(19) United States
(12) Patent Application Publication
(10) Pub. No.: US 2003/0055613 A1
(43) Pub. Date: Mar. 20, 2003

(54) Semi-physical modeling of HEMT DC-to high frequency electrothermal characteristics

(75) Inventor: Roger S. Tsai, Torrance, CA (US)

Correspondence Address: Patent Counsel, TRW, Inc., Law Department, One Space Park, Building E2/6051, Redondo Beach, CA, 90278, US

(73) Assignee: TRW, Inc.

(21) Appl. No.: 09/840,545

(22) Filed: Apr. 23, 2001

Related U.S. Application Data
(60) Provisional application No. 60/200,648, filed on Apr. 28, 2000.
(60) Provisional application No. 60/200,307, filed on Apr. 28, 2000.
(60) Provisional application No. 60/200,810, filed on Apr. 28, 2000.
(60) Provisional application No. 60/200,290, filed on Apr. 28, 2000.
(60) Provisional application No. 60/200,666, filed on Apr. 28, 2000.
(60) Provisional application No. 60/200,622, filed on Apr. 28, 2000.
(60) Provisional application No. 60/200,302, filed on Apr. 28, 2000.

(51) Int. Cl. G06F 17/10

(52) U.S. Cl. 703/2

(57) ABSTRACT

A method for modeling semiconductors which utilizes a semiphysical device model coupled with an analytical thermal resistance model to self consistently solve for the channel temperature and internal charge/electric field structure of the semiconductor device. As such the method in accordance with the present invention realistically simulates the response of electrical performance to temperature and vice versa.

### CROSS-REFERENCE TO RELATED APPLICATIONS

This application is a continuation-in-part and claims the priority of U.S. patent application Ser. No. 60/200,648, filed on Apr. 28, 2000.

This application is related to the following commonly-owned co-pending patent application Ser. No. 09/680,339, filed on Oct. 5, 2000: METHOD FOR UNIQUE DETERMINATION OF FET EQUIVALENT CIRCUIT MODEL PARAMETERS, by Roger Tsai. This application is also related to the following commonly-owned co-pending patent applications all filed on Apr. 28, 2000, S-PARAMETER MICROSCOPY FOR SEMICONDUCTOR DEVICES, by Roger Tsai, Ser. No. 60/200,307, (Attorney Docket No. 12-1114); EMBEDDING PARASITIC MODEL FOR PI-FET LAYOUTS, by Roger Tsai, Ser. No. 60/200,810, (Attorney Docket No. 12-1116); SEMI-PHYSICAL MODELING OF HEMT HIGH FREQUENCY NOISE EQUIVALENT CIRCUIT MODELS, by Roger Tsai, Ser. No. 60/200,290, (Attorney Docket No. 12-1119); SEMI-PHYSICAL MODELING OF HEMT HIGH FREQUENCY SMALL-SIGNAL EQUIVALENT CIRCUIT MODELS, by Roger Tsai, Ser. No. 60/200,666, (Attorney Docket No. 12-1120); HYBRID SEMI-PHYSICAL AND DATA FITTING HEMT MODELING APPROACH FOR LARGE SIGNAL AND NON-LINEAR MICROWAVE/MILLIMETER WAVE CIRCUIT CAD, by Roger Tsai and Yaochung Chen, Ser. No. 60/200,622, (Attorney Docket No. 12-1127; and PM²: PROCESS PERTURBATION TO MEASURE MODEL METHOD FOR SEMICONDUCTOR DEVICE TECHNOLOGY MODELING, by Roger Tsai, Ser. No. 60/200,302, (Attorney Docket No. 12-1128).

### BACKGROUND OF THE INVENTION

1. Field of the Invention

The present invention relates to a method for modeling a semiconductor device and more particularly to a method of modeling the thermal and electrical characteristics of a semiconductor device which utilizes a semiphyscial device model coupled with an analytical thermal resistance model to self consistently solve for the channel temperature and internal charge/electrical field structure of the semiconductor device.

2. Description of the Prior Art

HEMT technology provides RF components that have unparalleled, high performance characteristics at high frequencies (microwave to millimeter wave) and high power levels. As such, HEMTs are known to be used in various RF applications. Unfortunately, high power level applications also require high levels of DC power dissipation that elevates the HEMT components to high temperature levels. Currently, there are two predominant methods for modeling the electrothermal and thermal characteristics of HEMT device; finite element thermal simulation and physical device simulation

Finite element thermal simulations are used to simulate the lay out dependent thermal conducting characteristics of a semiconductor device. The simulation may be accomplished either by simulating the two dimensional cross section of the device lay out and then assuming semi-infinite thermal conditions in the orthogonal direction; so called quasi-three dimensional modeling; or filly simulating the three dimensional device layout. Because the full three dimensional approach requires much more computational power and sophisticated software, the quasi-three dimensional approach is known to be in more common use. A typical example of this approach is shown in FIG. 1 which depicts a finite element mesh for a HEMT device layout. The device layout is typical of all HEMT devices.

Finite element thermal simulations are known to provide accurate estimations of a devices thermal conduction. However, the main draw back with this method is the inability to couple the calculated channel temperature of the device back to an electrical simulation in order adjust the electrical characteristics of the device. In addition, this approach assumes a heat source, typically DC power dissipated within the intrinsic device which remains constant. However, in reality the DC power dissipation also changes with temperature. Thus, for an accurate electrothermal simulation, the so-called self heating effect must be taken in account.

As mentioned above, the full electrothermal characteristics can be simulated from so-called physical device simulators. Physical device simulators are known to utilize comprehensive knowledge about material characteristics and basic device physics to simulate the physical operation within the structure of the device. Usually simulators are based upon finite element or Monte Carlo approaches—although the finite element approach is usually employed for electrothermal simulations that also incorporate thermal conduction. Because these tools use the physical structure to simulate performance, the correspondence between the simulated electrothermal performance and the devices physical characteristics are relatively strong. However, the ability of device simulators to accurately model real, measured high frequency electrical characteristics is relatively inaccurate. Usually such simulation tools are able to achieve fairly useable modeling of DC characteristics but cannot be used for accurate high frequency simulations. Thus, there is a need for an electrothermal semiconductor device model which provides relatively accurate results at high frequencies.

### SUMMARY OF THE INVENTION

Briefly the present invention relates to a method for modeling semiconductor devices which utilizes a semiphysical device model coupled with an analytical thermal resistance model to self consistently solve for the channel temperature and internal charge/electric field structure of the semiconductor device. As such the method in accordance with the present invention can realistically simulate the response of electrical performance to temperature and vice versa of a semiconductor device.

### DESCRIPTION OF THE DRAWINGS

These and other advantages of the present invention will be readily understood with reference to the following specification and attached drawings wherein:

FIG. 1 illustrates a known finite element mesh for a HEMT device layout.

FIG. 2 is a graphical illustration illustrating the measured semi-physical modeled DC-IV characteristics at an ambrent temperature of 200° C.

FIG. 3 is similar to FIG. 2 but at an ambient temperature of 25° C.

FIG. 4 is a graphical illustration illustrating the measured vs semiphyically modeled DC-IV characteristics at an ambient temperature of 25° C. for a self heating large periphery 8 fingered 600 μm gate periphery device cell.

FIG. 5 is schematic diagram of an exemplary small signal equivalent circuit model for a HEMT device.

FIG. 6 is a sectional view of an exemplary HEMT illustrating the rough translation of the physical origins for each of the equivalent circuit elements illustrated in the small signal circuit model in FIG. 1.

FIG. 7 is a cross-sectional view of a HEMT illustrating the regions in the HEMT which correspond to the various circuit elements in the small signal equivalent circuit model illustrated in FIG. 5.

FIG. 8 is an example of a relatively accurate measured-to-model I-V characteristics using the semi-physical modeling method in accordance with one aspect of the present invention.

FIG. 9 is a elevational view illustrating an epi stack for an exemplary HEMT.

FIG. 10 is a cross-sectional view of a HEMT and an exemplary epi stack.

FIG. 11 is a blown up diagram of the cross-sectional parameters pertaining to the T-gate geometry for the exemplary epi stack illustrated in FIG. 7.

FIG. 12 is a diagram of an electric conductance model used in the semi-physical example.

FIG. 13 is a Smith chart illustrating the measured vs modeled S-parameters S11, S12 and S22 simulated in accordance with the method in accordance with the present invention.

FIG. 14 illustrates the measured vs modeled values for the S21 parameter.

FIG. 15 is similar to FIG. 14 but for the S12 S-parameter.

FIG. 16 represents an exemplary S-parameter microscope in accordance with the present invention.

FIG. 17 illustrates the internal and external regions of an exemplary HEMT device.

FIG. 18 is similar to FIG. 16 but illustrates the approximate locations of the model elements in the HEMT FET device illustrated is FIG. 16.

FIG. 19 is a schematic diagram of a common source FET equivalent circuit model.

FIG. 20 is an illustration of specific application of the S-parameter microscope illustrated in FIG. 16.

FIG. 21 is similar to FIG. 16 which demonstrates the inability of known systems to accurately predict the internal charge and electrical field structure of a semiconductor device.

FIG. 22 is a plan view of a four-fingered, 200 μm GaAs HEMT device.

FIG. 23 is a graphical illustration illustrating the measured drain-to-source current I_{ds} as a function of drain-to-source voltage Vds for the sample FET device illustrated in FIG. 22.

FIG. 24 is a graphical illustration illustrating the drain-to-source current I_{ds} and transconductance Gₘ as a function of the gate-to-source voltage V_{gs} of the sample FET device illustrated in FIG. 22.

FIG. 25 is a Smith chart illustrating the measured S11, S12 and S22 parameters from frequencies of 0.05 to 40.0 GHz for the FET device illustrated in FIG. 22.

FIG. 26 is a graphical illustration of the magnitude as a function of angle for the S21 S-parameter for frequencies of 0.05 to 40 GHz for the exemplary FET illustrated in FIG. 22.

FIG. 27 is a graphical illustration of a charge control map of the charge and electric field distribution in the on mesa source access region shown with Rₛ as a function bias in accordance with the present invention.

FIG. 28 is a graphical illustration of a charge control map of charge and electric field distribution in the on-mesa drain access region shown with R_{d} as a function of bias in accordance with the present invention.

FIG. 29 is a graphical illustration of a charge control map for the non-quasi static majority carrier transport, shown with Rᵢ as a function of bias in accordance with the present invention.

FIG. 30 is a graphical illustration of a charge control map for gate modulated charge and distribution under the gate, shown with Cgs and Cgt as function of bias in accordance with the present invention.

FIG. 31 is a plan view of an exemplary π-FET with two gate fingers.

FIG. 32 is a plan view of a π-FET with four gate fingers.

FIG. 33 is an illustration of a π-FET parasitic model in accordance with the present invention.

FIG. 34 is an illustration of an off-mesa parasitic model for a π-FET in accordance with the present invention.

FIG. 35 is an illustration of an interconnect and boundary parasitic model in accordance with the present invention for the π-FET with four gate fingers as illustrated in FIG. 32.

FIG. 36 is an illustration of an inter-electrode parasitic model in accordance with the present invention.

FIG. 37 is a schematic diagram of the inter-electrode parasitic model illustrated in FIG. 36.

FIG. 38 is an illustration of an on-mesa parasitic model in accordance with the present invention.

FIG. 39 is a schematic diagram of the on-mesa parasitic model illustrated in FIG. 41.

FIG. 40 is an illustration of an intrinsic model in accordance with the present invention.

FIG. 41 is a schematic diagram of the intrinsic model illustrated in FIG. 40.

FIG. 42A is an exemplary device layout of a π-FET with four gate fingers.

FIG. 42B is an equivalent circuit model for the π-FET illustrated in FIG. 42A.

FIG. 43 is a single finger unit device cell intrinsic model in accordance with the present invention.

FIG. 44 is similar to FIG. 43 and illustrates the first level of embedding in accordance with the present invention.

FIG. 45 is similar to FIG. 43 and illustrates the second level of embedding in accordance with the present invention.

FIG. 46 is an equivalent circuit model of the π-FET illustrated in FIG. 42A in accordance with the present invention.

FIG. 47 is similar to FIG. 45 and illustrates the third level of embedding in accordance with the present invention.

FIG. 48 is similar to FIG. 45 and illustrates the fourth level of embedding in accordance with the present invention.

FIG. 49 is similar to FIG. 45 and illustrates the fifth level of embedding in accordance with the present invention.

FIGS. 50A and 50B is a flow chart of a parameter extraction modeling algorithm that forms a part of the present invention.

FIGS. 51 and 52 represent the error metric in accordance with the present invention.

FIG. 53A is a Smith chart illustrating the measured versus the initial model solutions for the S11, S12 and S22 S-parameters from frequencies from 0.05 to 40.0 GHz.

FIG. 53B is a graphical illustration of angle versus magnitude for the initially modeled S-parameter S21 from frequencies of 0.05 to 40 GHz.

FIG. 54A is a Smith chart illustrating the measured versus simulated S-parameters S11, S12 and S22 for frequencies 0.05 to 40 GHz for the first extraction optimization cycle.

FIG. 54B is a graphical illustration of magnitude as a function of angle for the measure and first optimized model S-21 parameter for frequencies 0.05 to 40 GHz for the first optimization cycle.

FIG. 55A is a Smith chart illustrating the measure as a function of the final model solution for S-parameters S 11, S 12 and S22 for frequencies 0.05 to 40 GHZ for the final solution.

FIG. 55B is a graphical illustrations of the magnitude as a function of an angle for S-parameter S21 for the final model solution from frequency 0.05 to 40 GHz.

FIG. 56 is a graphical illustration of the semi-physically modeled vs measured small signal Gm.

FIG. 57 is a graphical illustration of the semi-physically simulated bias dependence of the small-signal output conductance Rds.

FIG. 58 is a graphical illustration of the semi-physically simulated bias dependence of the small signal gate-source and gate-drain capacitance Cgs and Cgd.

FIG. 59 is a graphical illustration of the semi-physically simulated bias dependence of the small signal gate source charging resistance Ri.

FIG. 60 is a graphical illustration of the semi-physically bias dependence of the small signal source and drain resistance Rs and Rd.

FIG. 61 is a graphical illustration of the measured vs modeled bias dependent gain at 23.5 Ghz for a K-band MMIC amplifier.

FIGS. 62A and 62B are graphical illustration of the extracted parameters from measured device I-V's for process control monitor testing.

FIG. 63 is a graphical illustration of the measured vs semi-physically simulated process variation for Gmpk and Vspk.

FIG. 64 is a graphical illustration of the measured vs semi-physically simulated process variation for Idpk and Gmpk.

FIG. 65 is a graphical illustration of the measured vs semi-physically simulated process variation for Imax and Vpo.

FIG. 66 is a graphical illustration of the measured/extracted vs semi-physically simulated process variation for the small signal equivalent model Rds and Gm.

FIG. 67 is a graphical illustration of the measured/extracted vs semi-physically simulated process variation for the small signal equivalent model Cgs and Gm.

FIG. 68 is a graphical illustration of the measured vs semi-physically simulated physical dependence for Imax as a function of physical gate length.

FIG. 69 is a graphical illustration of the measured/extracted model vs semi-physically simulated physical dependence for Rds as a function of physical recess undercut width.

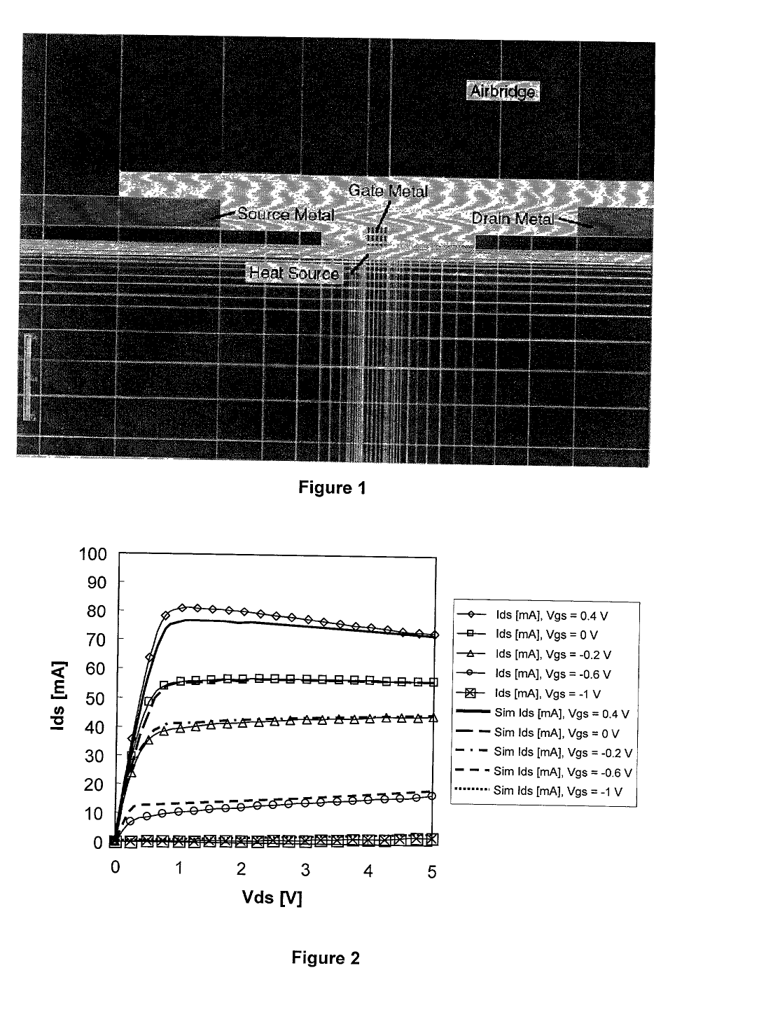

### DETAILED DESCRIPTION

The model in accordance with the present invention utilizes a semi physical device model that is coupled to an analytical thermal conductance model as a means of simulating the electrothermal performance characteristics of a semiconductor device. In particular, a semiphysical model for HEMT devices is demonstrated that is able to relatively accurately represent small signal, noise, non-linear and large signal characteristics. In order to incorporate temperature dependence and also layout dependence of thermal conductivity, the following procedure is utilized:

1) Derive a Semi-Physical device model that is able to replicate measured DC I-V characteristics and bias-dependent small-signal characteristics very accurately at room temperature.

2) Incorporate any known temperature dependence of material parameters.

3) MeasureDC-IV's and bias-dependent small-signal S-parameters across the desired range of temperatures.

4) Extract small-signal equivalent circuit models for each of the S-parameter measurement vs temperature. S-parameter microscopy as discussed below may be used to develop charge-control map solutions.

5) Develop temperature coefficient expressions that apply to the intrinsic device model expressions of the semi-physical model. These temperature coefficients must adjust the predictions of the semi-physical device model to match the measured DC and small-signal data at each temperature. In particular:

a) I-V's must be matched.

b) If conventional, prior art small-signal model extraction is performed, for example, Minasian extraction algorithms, as discussed in detail in “Broad Band Determination of the FET Small-Signal Equivalent Circuit”, by Berroth, et al., IEEE-MTT, Vol. 38, No. 7, July 1990. relative changes in the C-V's (capacitance-VS-voltage) must be matched by the semi-physical model predictions.

c) If S-parameter microscopy is performed, absolute changes in the C-V's must be matched to the semi-physical model.

6) Implement an appropriate analytical thermal conduction model.

7) Couple the semi-physical device model and the analytical thermal conduction model by:

a) Substituting the “environmental temperature” that operates in all of the temperature-dependent terms and temperature coefficients with “channel temperature”

b) Using the semi-physically modeled length of the saturated region, XSAT, as the length of the heat-generating region.

As will be discussed below, the semiphysical HEMT model may be extended to perform fill electrothermal device simulations. In accordance with the above, a semiphysical model mentioned in step 1 is discussed below. In step 2, reported thermal properties of the material systems used for the HEMT technology are incorporated into an appropriate material related expression of the semiphysical device model. These properties may be obtained from “GaAs, AlAs and AlxGa1-xAs Materials Parameters For Use and Research and Device Applications” by S. Adachi, J. Appl. Phys, vol. 58, No. 3, August 1985, hereby incorporated by reference. In step number 3, the DC I-V and bias dependent S-parameters are measured for a standard device lay out across several base plate temperatures; for example −25° C., 25° C., 125° C. and 200° C. In step 4, S-parameter microscopy is employed for each set of temperature dependent data. In step 5, a temperature compensation co-efficient is developed from reported material thermal dependance relationships, for example, as shown below.

| | | | |
|---|---|---|---|
| Ambient Temperature Coefficient | TCamb | [] | = 1.247AI_{xspace} + 1.5In_{y} − 0.4In_{y}² + (T_{amb} − 300)(−3.95 − 1.15* AI_{xspace})*0.0001 |
| Room Temperature Coefficient | TCref | [] | = 1.247AI_{xspace} + 1.5In_{y} − 0.4In_{y}² + (273 − 300)(−3.95 − 1.15*AI_{xspace})*0.0001 |
| Temperature Coefficient Factor | TCF | [] | TC_{amb}/TC_{ref} |

Once the expression, TCF is applied to the appropriate semi-physical charge and transport control equations, temperature dependent I-V and C-V characteristics are accurately fit. As shown, the equations below illustrate how key charge control and carrier transport relationships are enhanced to incorporate temperature dependence through the empirical temperature compensation term set forth below:

| | | | |
|---|---|---|---|
| Maximum Channel Charge | Nₘₐₓ | [cm⁻²] | = (Nₘₐₓ₀ + N_{maxL} V_{ds}^{nnmax} |
| | | | H_{chan}/H_{chanREF}) * TC_{F} |
| Parasitic Charge Accumulation in the Donor Layer | N_{sDonor} | [cm⁻²] | = Nₛ^{′} + Nₛ) * (dᵢ + ^{Δ}dᵢ) MshKpar * V_{gte}/ |
| | | | (dᵢ + ^{Δ}dᵢ − d_{iT} * TC_{F}) |
| Saturation Velocity | Vₛ | [cm/s] | 1.47E + 07 * TC_{F)} |

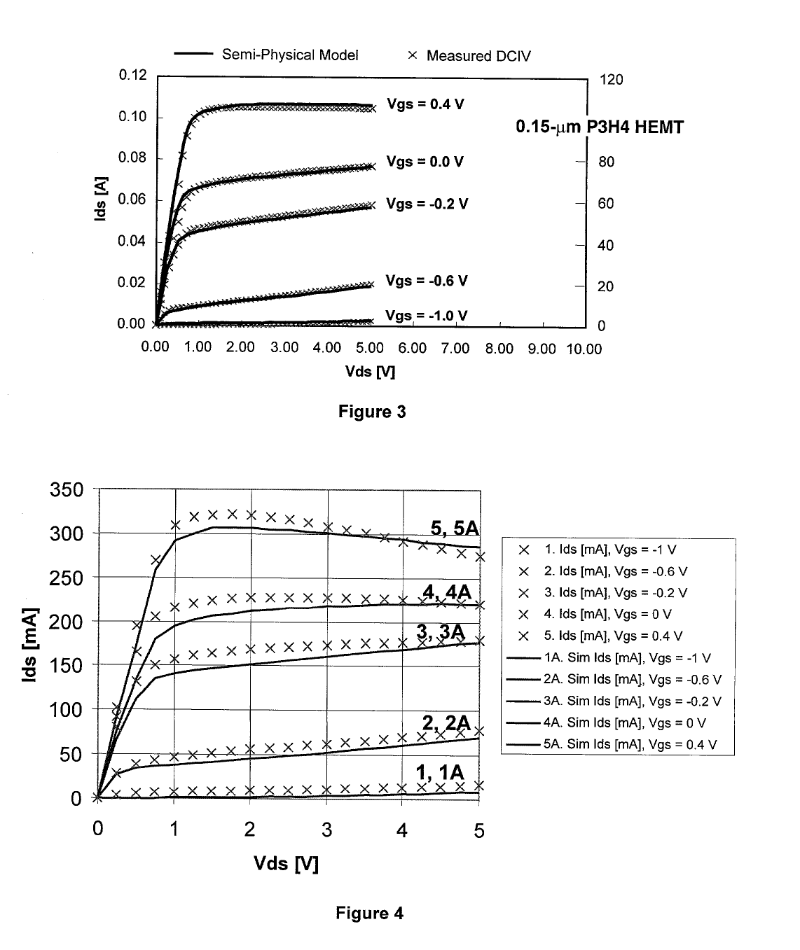

FIG. 3 demonstrates the enhanced semiphysical device model now able to accurately simulate I-V characteristics at 200° C., while FIG. 4 demonstrates the accuracy of the I-V simulation at 25° C. Thus, the semiphysical model, which can be derived at room temperature can be modified with empirical temperature coefficients to incorporate accurate temperature dependence.

In step 6, the analytical thermal conduction expression is as set forth in “Precise Technique Finds FET Thermal Resistance” by H. Cooke, “Microwaves and RF”, August 1986. Lastly, in step 7, gate length, which is taken to be the length of the heat-generating region in Cooke's expressions, is replaced by a semiphyically modeled XSAT expression provided below.

| | | | |
|---|---|---|---|
| | | | = X_{s0 {M}_{Xs}[1/(1 +(V_{ds}/Vₛₐₜₙ)^{m})(^{1/m)} |
| | | | V_{ds}m (V_{ds}/Vₛₐₜₙ)^{m - 1)}/{ |
| | | | Vₛₐₜₙm[1 + (V_{ds}/Vₛₐₜₙ)^{m}]^{(1/m + 1)}}] |
| Position of the Boundary between Regions 1 and 2 | X_{S} | [μ^{m}] | V_{ds} M_{XsL} + V_{gte}M_{XsK }} |
| | | | = δ^{X} {1 + [^{L}_{geff} − Xₛ − L_{g} + X_{satREF}]/(² δ^{X}) |
| | | | + sqrt (δ² + ([^{L}_{geff} − Δ^{L}ₛ − ^{X}ₛ − ^{L}_{g} + ^{X}_{satREF}]/(2 δ^{X}) − 1)² |
| Length of the Saturated Region, Region 2, under the Gate | X_{SAT} | [μ^{m}] | } |
| Length of the Linear Region, Region 1 | L₁ | [μ^{m}] | = L_{geff} − X_{SAT} |
| | | | = δ^{X} {1 + [^{L}_{gs} − ^{L}₁]/(² δ^{X}) |
| Total Length of the Saturated Region, Region 2 | L₂ | [μ^{m}] | + sqrt (δ² + ([^{L}_{gs} − ^{L}₁]/(² δ^{X}) − 1)² } |

In Cooke's original derivation, it is assumed that the heat-source within the FET can be approximated by a uniform source for the length of the physical gate length. In reality, a more accurate expression for this heat source would have a length equal to the saturation region's length, or XSAT. Most of the drain voltage, and hence most of the DC power dissipation is dropped across this region, thus making this dimension more suitable to describe the source of heat.

The temperature compensation coefficient is modified to operate between the “channel temperature” rather the “ambient temp erature” as generally shown by the equations provided below.

| | | |
|---|---|---|
| Ambient Temperature Coefficient TCchan | [] | = 1.247Al_{yspace} + 1.5ln_{y} − 0.4ln_{y}² + (T_{chan} − 300)(−3.95-1.15*Al_{yspace})*0.0001 |
| Room Temperature Coefficient TOref | [] | = 1.247Al_{yspace} + 1.5ln_{y} − 0.4ln_{y}² + (273 − 300)(−3.95 − 1.15*Al_{yspace})*0.0001 |
| Temperature Coefficient Factor | [] | = TC_{chan}/TC_{ref} |

The distinction between TCF and TCF′ is that the TCF is a temperature coefficient determined through complete, uniform heating of the device sample. When “base-plate” heating is used to heat the device sample, it can be assumed that base-plate temperatures are roughly equal to the “channel temperature”, or rather the temperature of the device is the same as the surrounding environment.

The implementation of Cooke's method coupled with the semi-physical device model results in the equations below:

| | | | |
|---|---|---|---|
| Channel Temperature | T_{CH} | [° C.] | =Θ P_{CHSAT} W_{g}/1000 + Tₛᵢₙₖ − 273 |
| | | | = N_{f}/{2^{π}[(N_{f} − 1)/In(M) − (N_{f} − 2)/In(P)][K_{TH}W_{g}/1e7 |
| Thermal Conductivity | Θ | [° C./mW] | ]} |
| Power Dissipation over the Saturated Region | P_{CHSAT} | [mW/mm] | = I_{dsW} * V_{CHSAT} * 10⁶ |
| | | | = {2 sqrt{cosh [^{π}[d_{ffd} + X_{SAT})/(4H_{sub})] |
| | | | cosh [^{π}(d_{ffd} − X_{SAT})/(4H_{sub})]} +1}/ |
| | | | {sqrt { cosh [^{π}(d_{ffd} + X_{SAT})/(4H_{sub})] |
| Cooke's “M” parameter | M | [] | cosh [^{π}(d_{ffd} − X_{SAT})/(4H_{sub})]} − 1 } |
| | | | = 2 sqrt {[1 + 1/cosh[^{π}(d_{ffd} + X_{SAT})/(4H_{sub})]]/ |
| Cooke's “P” parameter | P | [] | [1 − 1/cosh [^{π}(d_{ffd} − X_{SAT})/(4H_{sub})]]} |
| Thermal Resistance | KTH | [W/cm⁰C] | |
| Drain Current/unit Gate Width | I_{dsW} | [A/_{μ}m] | = I_{ds}/W_{g} |

When the device is dissipating a lot of power and thus unable to outflow this heat effectively because of finite thermal conductance, then the device enters a thermal regime known as “self-heating”. In self-heating, areas adjacent to the device's heat sources, or that region approximately under the gate, are heated to higher temperatures than the base-plate. As a result, the device becomes hotter than its surrounding environment. In this regime, “channel temperature” must be used to gauge how hot the intrinsic device gets.

As an example of how the formulation accurately models self-heating effects, a large periphery 8-fingered 600 μm total gate periphery device cell was tested for DC-IV and S-parameter at room temperature. This particular device layout dissipates too much DC power at high drain voltage or high drain current that could be effectively removed by thermal conduction. As a result, the device suffers from dramatic self-heating. As shown in FIG. 4, the electrothermal model in the semi-physical device model is able to relatively closely simulate the effect of the self-heating channel temperature upon the electrical performance of the device.

### SEMI PHYSICAL MODEL

Semi-physical device modeling represents both the physical device characteristics and measured characteristics, which can be used to simulate RF performance through physically-based device models. The semi-physical model is an analytical model based upon empirical expressions that model the physics of HEMT operation, hence the terminology “semi-physical”. The model incorporates real process parameters, such as gate length recess etch depth, recess undercut dimensions, passivation nitrite thickness, and the like. By using empirical expressions, the semi-physical model is able to maintain relatively good measured to model accuracy while accounting for the effects of process variations on the device performance.

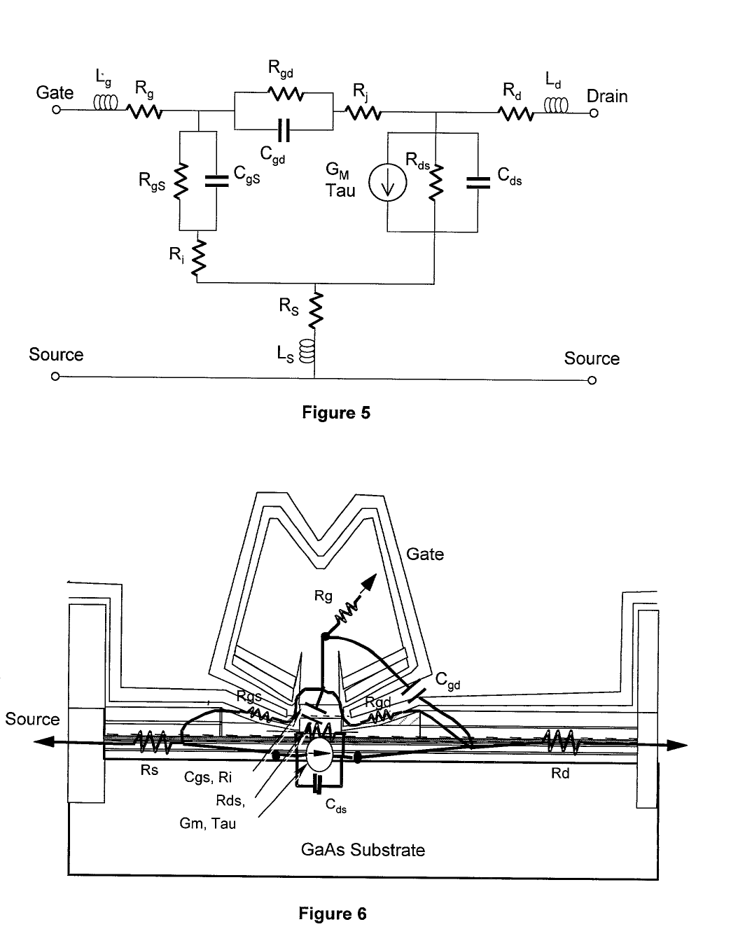

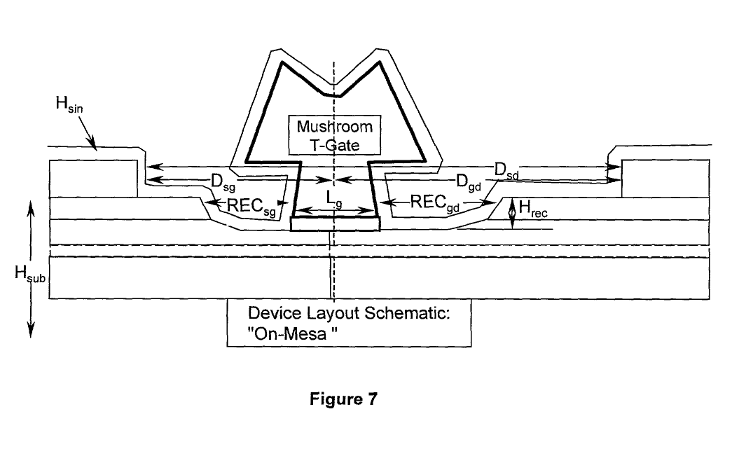

The semi-physical model provides model elements for the standard small signal equivalent circuit model or FET is illustrated in FIG. 5. FIG. 6 is a rough translation of the physical origins for each of the equivalent circuit elements in the small-signal equivalent circuit model illustrated in FIG. 5. FIG. 7 is a cross-sectional drawing of an exemplary HEMT device structure. However, unlike conventional methods, the model elements are derived from small signal excitation analysis of the intrinsic charge and electric fields within the device. As such, the simulated small signal model elements represent a relatively accurate physical equivalent circuit description of a physical FET.

The general methodology for the semi-physical modeling of intrinsic charge, electrical conductance and the electrical field are as set forth below. First, the relationships between the conduction band offsets, electrical permitivities and material composition for the various materials in the epi stack are determined. These relationships can be performed analytically or by fitting simulated data from physical simulators. Subsequently, the basic electron transport characteristics in any of the applicable bulk materials in the epi stack are determined. Once the electron transport characteristics are determined, the undeleted linear channel mobility is determined either through material characterization or physical simulation. Subsequently, the Schottky barrier height value or expressions are determined. Once the Schottky barrier height value is determined, the semi-physical equations are constructed modeling the following characteristics:

Fundamental-charge control physics for sheet charge in the active channel as controlled by the gate terminal voltage.

Average centroid position of the sheet charge within the active channel width.

Position of charge partitioning boundaries as a function of gate, drain and source terminal voltages.

Bias dependence of linear channel mobility and surface depleted region.

Bias dependence of the velocity saturating electric field in the channel.

Saturated electron velocity.

Electrical conductance within the linear region of the channel under the gate.

Electrical conductance within the source and drain access regions

Once the semi-physical equations are determined, the empirical terms of the semi-physical modeling equations are adjusted to fit the model I-V (current-voltage) characteristics against measured values. Subsequently, the empirical terms are interactively readjusted to achieve a simultaneous fit of measured C-V (capacitance-voltage) and I-V characteristics. Lastly, the empirical modeling terms are fixed for future use.

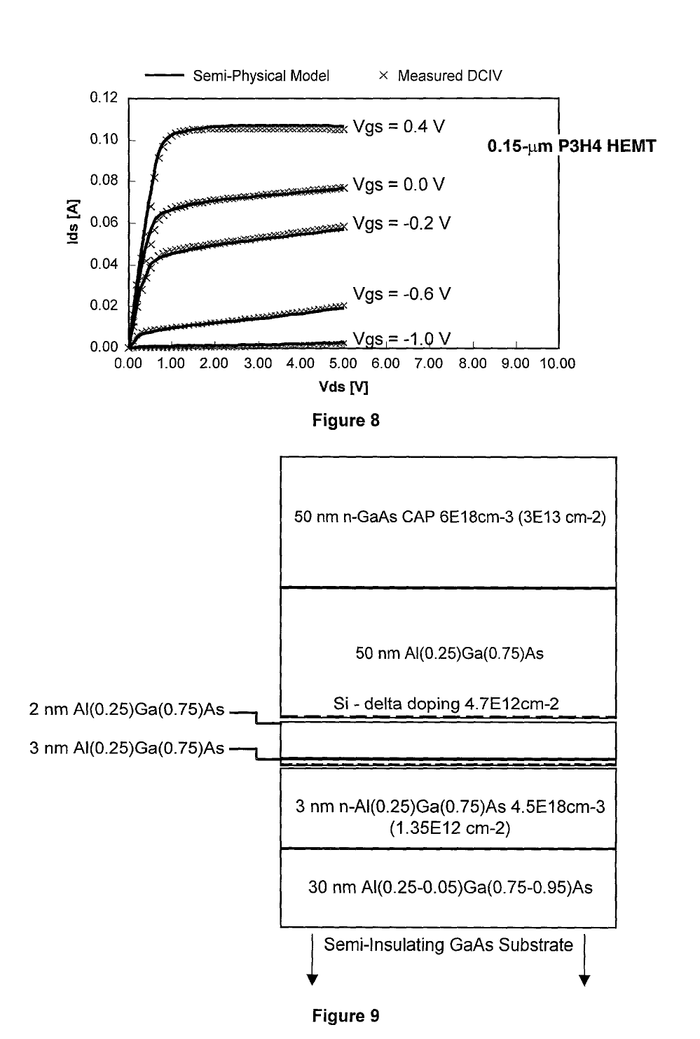

By constructing a comprehensive set of semi-physical equations that cover all of the physical phenomenon as mentioned above, the physical operating mechanisms within a HEMT device can be relatively accurately determined. FIG. 8 illustrates a set of relatively accurate measured-to-modeled I-V characteristics for a HEMT using the semi-physical modeling discussed herein. In particular, FIG. 8 illustrates the drain-to-source current I_{ds} as a function of the drain-to-source voltage V_{ds} for various gate biases, for example, from 0.4V to −1.0V. As shown in FIG. 8, solid lines are used to represent the semi-physical model while the Xs are used to represent measured values. As shown in FIG. 8, a close relationship exists between the measured values and the modeled parameters.

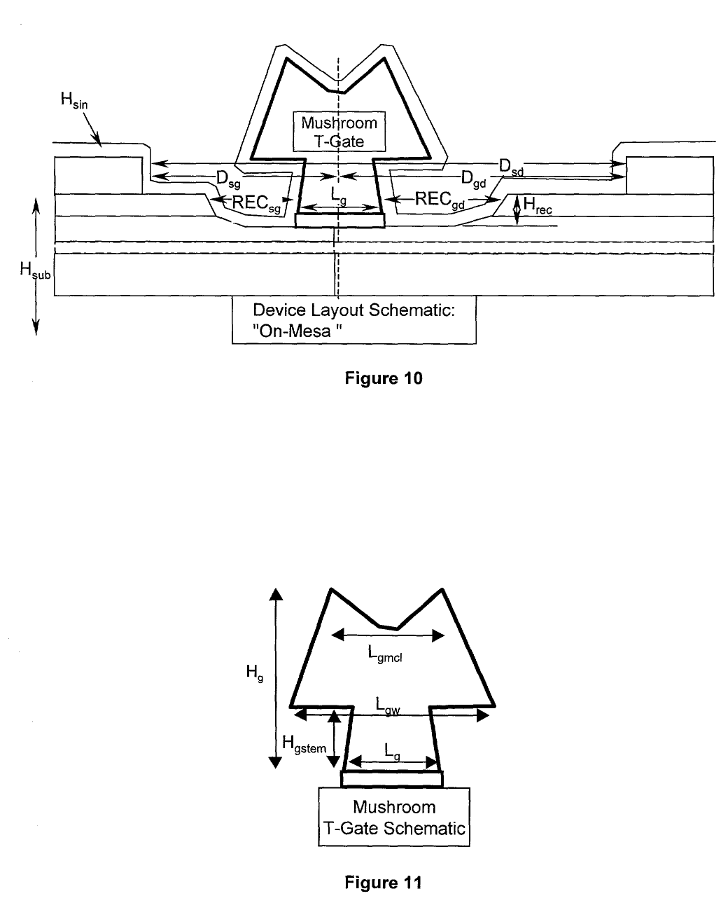

An example of semi-physical modeling for physical device operation in accordance with the present invention is provided below. The example utilizes an exemplary device as illustrated in FIGS. 9 and 10. Table 2 represents exemplary values for the physical cross-section parameters in the model. FIG. 11 relates to a blown up T-gate characteristic which is correlated to the parameters identified in Table 1.

TABLE 1
Values for the Physical Dimension Parameters Input
into Device Cross Section

| Layout Parameter | | Units | Value |
|---|---|---|---|
| Gate Length | Lg | [^{μ}m] | 0.150 |
| Wing Length | Lgw | [^{μ}m] | 0.520 |
| Gate Mushroom Crown Length | Lgmcl | [^{μ}m] | 0.200 |
| Total Gate Height | Hg | [^{μ}m] | 0.650 |
| Gate Stem Height | Hgstem | [^{μ}m] | 0.300 |
| Gate Sag Height | Hgsag | [^{μ}m] | 0.100 |
| Gate Cross-Sectional Area | GateArea | [^{μ}m^{2]} | 0.187 |
| Max Cross-Sectional Area | MaxArea | [^{μ}m^{2]} | 0.364 |
| Total Gate Periph | Wg | [^{μ}m] | 200.000 |
| # Fingers | N | [] | 4.000 |
| Source-Drain Spacing | Dsd | [^{μ}m] | 1.800 |
| Gate-Source Spacing | Dsg | [^{μ}m] | 0.700 |
| Gate-Drain Spacing | Dgd | [^{μ}m] | 1.100 |
| Gate-Source Recess | RECsg | [^{μ}m] | 0.160 |
| Gate-Drain Recess | RECgd | [^{μ}m] | 0.240 |
| Recess Etch Depth | Hrec | [A] | 780.000 |
| SiN Thickness | Hsin | [A] | 750.000 |
| Gatefeed-Mesa Spacing | Dgfm | [^{μ}m] | 2.000 |
| Gateend-Mesa Overlap | Dgem | [^{μ}m] | 2.000 |
| Finger-Finger Spacing Thru Drain | Dffd | [^{μ}m] | 16.500 |
| Finger-Finger Spacing Thru Source | Dffs | [^{μ}m] | 13.500 |
| Source Airbridge Inset | AB? | [] | P |
| Source Airbridge Inset | Dsabin | [^{μ}m] | 28.000 |
| Source Airbridge Height | Hsab | [^{μ}m] | 3.500 |
| Source-Gate Airbridge Clearance | Hgsab | [^{μ}m] | 1.640 |
| Source Pad Width | Ws | [^{μ}m] | 12.000 |
| Drain Pad Width | Wd | [^{μ}m] | 14.000 |
| Substrate Thickness | Hsub | [^{μ}m] | 100.000 |

As mentioned above, the semi-physical modeling of the intrinsic charge and electric field within the HEMT device is initiated by determining the relationships between the conduction band offset, electric permitivities and material composition for the various materials in the epi stack. Material composition related band offset and electric permitivity relationships may be obtained from various references, such as “Physics of Semiconductor Devices,” by Michael Shur, Prentice Hall, Englewood Cliffs, N.J. 1990. The basic electron transport characteristics, for example, for the linear mobility of electron carriers in the bulk GaAs cap layer may be determined to be 1350 cm²/Vs, available from “Physics of Semiconductor Devices”, supra. The linear mobility of electron carriers in the undeleted channels is assumed to be 5500 cm²/Vs. This value may be measured by Hall effect samples which have epi stacks grown identically to the stack in the example, except for some differences in the GaAs cap layer. The Schottky barrier height is assumed to be 1.051 volts, which is typical of platinum metal on a AlGaAs material.

The following equations represent the semi-physical analytical expressions to model the charge control and centroid position in the sample.

| | | | |
|---|---|---|---|
| Empirical Charge Control Expression | Nₛ | [cm⁻²] | = Nₛ′/ |
| | | | [1 + (Nₛ′/Nₘₐₓ)^{γ})]^{1/γ} |
| Ideal Charge Control with Filling Law | Nₛ′ | [cm⁻²] | = 2 Nₒ In [1 + exp(V_{gt}/(^{η}Vₜₕ))] |
| Ideal Charge Control | Nₒ | [cm^{-2]} | = _{εi} η Vₜₕ/[2 q (dᵢ + ^{Δ}dᵢ) 10000] |
| | | | = (Nₘₐₓ₀ + N_{maxL} V_{ds}^{nnmax} |
| Maximum Channel Charge | Nₘₐₓ | [cm^{-2]} | H_{chan}/H_{chanREF}) |
| Initial Gate-Channel Voltage | V_{gt} | [V] | = V_{gs} − ^{Φ}_{b} − ^{Δ}E_{c} − V_{TO} −^{σ}V_{ds} |
| Threshold Voltage | V_{TO} | [V] | =^{Φ}_{b} − ^{Δ}E_{c} − V_{T} |
| Doping Threshold Voltage | V_{T} | [V] | =q N_{sdelta} ^{d}δ 10000/_{ε}_{ᵢ} |
| | | | = {(H_{space} + H_{bar} + H_{fdope} + H_{cap}) − H_{rec}}/ |
| Gate-to-Channel Spacing | dᵢ | [m] | (10¹⁰) |

note that the expression for di can be changed for different epi-stacks

| | | | |
|---|---|---|---|
| Movement of Sheet Carrier Centroid | Δ^{d}i | [m] | H_{chan} [ 1 − d_{iK} * V_{gte}/H_{chanREF} − |
| | | | d_{iL} · V_{ds}/H_{chanREF}] |
| Empirical Charge Control Shaping Parameter | γ | [] | |
| Semi-Physical Subthreshold Populating Rate | η | [] | |
| Dielectric Permitivity of the Barrier Layer | εₗ | [F/m] | |
| The thermal voltage | Vₜₕ | [V] | = K_{B}T_{amb}/ q |
| Ambient Temperature | T_{amb} | [K] | |
| Fixed Emprical Maximum Sheet Charge | Nₘₐₓ₀ | [cm⁻²] | |
| Vds Dependent Emprical Maximum Sheet Charge | N_{maxi.} | [cm⁻²] | |
| Vds Dependent Emprical Nmax shaping term | n_{Nmax} | [] | |
| Channel Layer Thickness | H_{chan} | [A] | |
| Reference Channel Layer Thickness | H_{chanREF} | [A] | |

(Channel Thickness for the sample for which the model was first denved)

| | | |
|---|---|---|
| Schottky Barrier Height | Φ_{B} | [V] |
| Conduction Band Offset between Channel and Barrier | Δ^{E}c | [V] |
| Front Delta Doping | N_{Sdelta} | [cm⁻²] |

note that this expression can be modified for non-delta doped epi-stacks

| | | | |
|---|---|---|---|
| Gate-to-Front Delta Doping Spacing | dδ | [m] | = {((H_{bar} + H_{fdope} + H_{cap}) − H_{rec}}/(10¹⁰) |
| Barrier Thickness between front doping and channel | H_{space} | [A] | |
| Barrier Layer Thickness before front doping layer | H_{bar} | [A] | |
| Front Doping layer thickness | H_{fdope} | [A] | |
| Cap layer thickness | H_{cap} | [A] | |
| Empirical Drain-Induced Barrier-Lowering Term | σ | [] | |
| Sheet Charge Position Gate Bias Factor | d_{iK} | [A/V] | |
| Sheet Charge Position Drain Bias Factor | d_{iL} | [A/V] | |
| Effective Gate Voltage | V_{gte} | [V] | = Vₜₕ [1 + V_{gt}/2V_{th +} |
| | | | sqrt (δ² + (V_{gt}/2Vₜₕ − 1)²] |
| Empirical Transition Width Parameter | δ | [] | |

As used herein, Ns represents the model sheet carrier concentration within the active channel. Ns' represents the ideal charge control law and is modeled as a semi-physical representative of the actual density of state filling rate for energy states within the channel v. gate voltage. The gate-to-channel voltage used for the charge control, Vgt, is a function of the Schottky barrier height, conduction band offsets and doping in the epi stack as is known in the art.

The following equations represent the semi-physical expression used to model the position of regional charge boundaries within the HEMT device. These expressions govern how to partition the model charge between the influence of different terminals.

| | | | |
|---|---|---|---|
| Effective Gate Length | L_{geff} | [μ^{m}] | =L_{g} + _{Δ}Lₛ + _{Δ}L_{d} |
| Gate-Source Control Region | L_{gs} | [μ^{m}] | = L_{g}/2 + _{Δ}Lₛ + X_{D1} |
| Source-Side Effective Gate Length Extension | _{Δ}Lₛ | [μm] | = _{Δ}Lₛ₀ + _{Δ}L_{K} * V_{gte} |
| Drain-Side Effective Gate Length Extension | _{Δ}L_{d} | [μ^{m}] | = _{Δ}L_{d0 +} _{Δ}L_{K} * V_{gte} + _{Δ}L_{L} * V_{dse2} |
| Gate-Drain Control Region | L_{gd} | [μ^{m}] | = (L_{g}/2 − _{Δ}L_{d}) * {tanh [10(L_{g}/2 + X_{D1})] + 1}/2 |
| | | | = X_{DL} V_{ds} M_{Xdl}/ |
| | | | {M_{XdK} V_{gte} * (1 + [X_{DL}V_{ds}M_{XdL}/ |
| Bias Dependent Extension of the Saturated Transport Region | X_{D1} | [μ^{m}] | (M_{XdK}V_{gte}(L_{g}/2 + REC_{gd}))]^{m}}^{1/m} |
| Empirical Drain-Saturated Transport Boundary Factor | X_{DL} | [μ^{m]} | = L_{g} V_{ds}/{2[1 + (V_{ds}/Vₛₐₜₑₙ)^{m}]^{(1/m)}} |
| | | | = Xₐ₀ {M_{Xs} [1/(1 + (V_{ds}/Vₛₐₜₙ)^{m})^{(1/m)} |
| | | | V_{ds}m(V_{ds}/Vₛₐₜₙ)^{(m 1)}/{ |
| | | | Vₛₐₜₙm[1 + (V_{ds}/Vₛₐₜₙ₎^{m}]^{(1/m + 1)}}] |
| Position of the Boundary between Regions 1 and 2 | X_{S} | [μ^{m]} | V_{ds}M_{Xsl} + V_{gte}M_{XsK} |

Note: Region 1 denotes the linear region, while Region 2 denotes the saturated region of the channel

| | | | |
|---|---|---|---|
| Empirical Effective Gate Length Extension Gate Bias Factor | _{Δ}L_{K} | [μ^{m/V}] | |
| Empirical Effective Gate Length Extension Drain Bias Factor | _{Δ}L_{L} | [μ^{m/V}] | |
| Effective Drain-Source Voltage Control-2 | V_{dse2} | [V] | = V_{ds}/[1 + (V_{ds}/Vₛₐₜₙ)^{m}]^{1/m} |
| Rough, Intrinsic Saturation Voltage | Vₛₐₜₙ | [V] | = Iₛₐₜ/g_{chi} |
| | | | = g_{chi} V_{gte}/ |
| Rough, Intrinsic Saturation Current Level | Iₛₐₜ | [A] | [1 + g_{chi}Rₛ + sqrt(1 + 2g_{chi}Rₛ + (V_{gte}/V_{L})²)] |
| Intrinsic Conductance of the Linear Region, Under the gate | g_{chi} | [S] | = (q Nₛ ^{μ}ₐᵥₑ Wg)/Lg |
| Rough Intrinsic Saturation Voltage Level | V_{L} | [V] | = Fₛ * L_{g} |
| Empirical Knee Shaping Parameter | m | [] | |
| Empirical Region 2 extension Drain Bias Factor | M_{XdL} | [] | |
| Empirical Region 2 extension Gate Bias Factor | M_{XdK} | [] | |
| Fine Intrinsic Saturation Voltage | Vₛₐₜₑₙ | [V] | = l _{satcom}/g_{chi} |
| | | | = g_{chi} V_{gte} V_{L} * [−V_{L}(A + g_{chi}Rₛ) + |
| | | | sqrt(V_{L}²(A + g_{chi}Rₛ)² + V_{gte}² − (g_{chi}RₛV_{L})²)]/ |
| Fine Intrinsic Saturation Current Level | I_{satcom} | [A] | [V_{gte}² (1 − g_{chi}Rₛ(V_{L}/V_{gte})²)] |
| Saturation Region Length Ratio | A | [] | = X_{S}/L_{geff} |
| Initial Starting position for Region 1 & 2 Boundary | X_{sD} | [μ^{m]} | = Lg/2 |
| Region1 & 2 Boundary Bias Factor | M_{Xs} | [] | |
| Region1 & 2 Boundary Drain Bias Factor | M_{XsL} | [] | |
| Region1 & 2 Boundary Drain Bias Factor | M_{XsK} | [] | |

The following equations represent is the semi-physical expression used to model the bias dependence of linear channel mobility in depleted regions.

| | | | |
|---|---|---|---|
| Depleted Channel Mobility | μave | [cm²V * s] | = ^{μ}_{dchan} + ^{μ}_{dK ·} ^{V}_{gte} |
| Fixed Depleted Channel Mobility | μdchan | [cm²/V * s] | |
| Depleted Channel Mobility Gate Bias Factor | μdK | [cm²/V² * s] | |

The following equations are the semi-physical expressions used to model the bias dependence of the saturating electric field and saturation velocity.

| | | | |
|---|---|---|---|
| Saturating Electric Field | F_{S} | [V/_{μ}m] | = Vₛ/ |
| | | | [(^{μ}ₛₐₜ + ^{μ}_{satK}V_{gte}) 10000] |
| Fixed Saturating Channel Mobility | μsat | [cm²/V * s] | |
| Saturating Channel Mobility Gate Bias Factor | μsatK | [cm²/V² * s] | |
| Saturation Velocity | Vₛ | [cm/s] | |

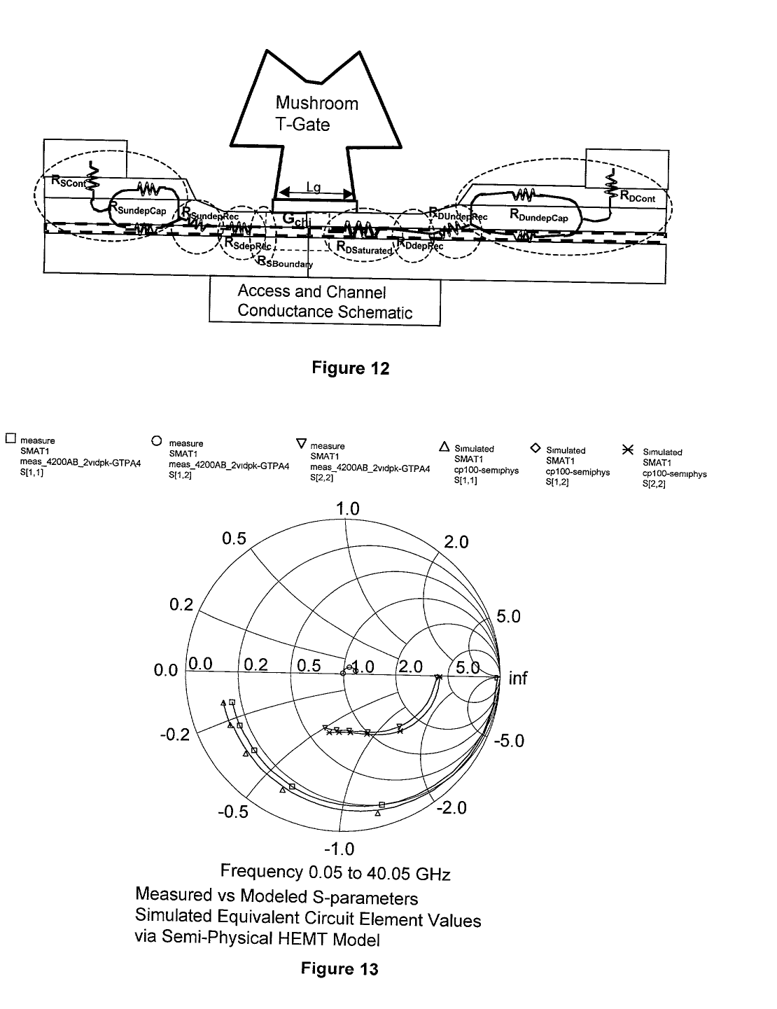

FIG. 12 is a schematically illustrates how electrical conductance in the source and drain access regions are modeled in the example.

The following equations describe the semi-physical model for the source access region conductance:

| | | | |
|---|---|---|---|
| Source Access Resistance | R_{S} | [Ω] | = (R_{SundepCap} + R_{SAccess} + R_{SBoundary})/W_{g} |
| | | | = R_{cont}/RF_{iconF} + |
| Source Access Resistance Channel and Cap | R_{S undepCap} | [Ω * μ^{m}] | R_{SH}[D_{sg} − (REC_{sg} + L_{g}/2)] |
| | | | = RsdepRec^{ON} * MRₛ * tanh{[KC_{fK} * ( |
| | | | V_{gs} − VC_{fOn} + V_{da} * MC_{fL})] + 1}/2 * {V_{gs} |
| | | | /2 * [1 − tanh(KRₛₖ (V_{gs} − VR_{sOn}))]}* {tanh [ |
| | | | KR_{sSat}(V_{ds} − VR_{sKnee})] + 1}/2 + R_{SundepRec} * }tanh[ |
| Source Access Resistance: Recess and Undepleted Cap | R_{SAccess} | [Ω * μ^{m}] | KR_{sK}(V_{gs} − VR_{sOn})] + 1}/2 |
| | | | = R_{SdepRec}^{ON} * MRₛ * tanh {[KR_{sK} * V_{gs} + KR_{sL}* V_{ds} + |
| | | | VR_{sOff] + 1}/2 * {(1 + V}_{ds}MR_{sL}) * MR_{sK} * (1 − |
| | | | tanh(KR_{sSat}(V_{ds} −VR_{aKnee}))]/ [2 * (1 + [V_{gs}/((1 + |
| Source Access Resistance: Crowding resistance due to conductance | R_{SBoundary} | [Ω * μ^{m}] | V_{ds}MR_{sL}) * MR_{sK)]}^{γRs})^{1/γRs)}]} |
| mismatch | | | |
| Resistance of the Source Recess Access region at high on-state bias | R_{S depRec}^{ON} | [Ω * μ^{m}] | = R_{SHdep} (REC_{ag}) |
| (Vₒₙ) | | | |
| Resistance of the Undepleted Source Recess Access region | R_{S undepRec} | [Ω * μ^{m}] | = R_{SHundep} (REC_{ag}) |
| Uncapped, Fully Depleted Sheet Resistance | R_{SHdep} | [Ω/sq] | =1/(q Nₘₐₓ ^{μ}ₐᵥₑ) |
| Capped, Undepleted Sheet Resistance | R_{SH} | [Ω/sq] | = 1/(1/R_{SHCap + 1/R}_{SHundep}) |
| Uncapped, Undepleted Sheet Resistance | R_{SHundep} | [Ω/sq] | = F_{surfUndep}/(q ^{N}ₘₐₓ ^{μ}_{undchan}) |
| Cap Sheet Resistance | R_{SHCap} | [Ω/sq] | = 1/[q N_{sCap} ^{μ}cap(H_{cap} − H_{capEtch})] |
| Surface Depletion Factor | F_{surfUndep} | [] | |
| High On-state bias: Diode Turn-on voltage | V_{ON} | [V] | = Φ_{b} − ^{Δ}E_{c} − ^{Δ}E_{f} |
| Ohmic Contact Resistance | R_{cont} | [Ω * μ^{m}] | |
| RF Ohmic Contact Resistance Reduction Factor | RF_{rconF} | [] | |
| Source Access Resistance Bias Modification Factor | MRₛ | [] | |
| Cf-Vds Bias Modification Factor | MC_{fL} | [] | |
| Rs-Vds Bias Modification Factor | MR_{sL} | [] | |
| Rs-Vgs Bias Modification Factor | MR_{sK} | [] | |
| Cf-Vgs Swith point to On-state | VC_{fOn} | [] | |
| Cf-Vgs Bias Expansion Factor | KC_{fK} | [] | |
| Rs-Vgs Swith point to On-state | VR_{SOn} | [] | |
| Rs-Vgs Swith point to Off-state | VR_{SOff} | [] | |
| Rs-Vds Swith point from Off-On transition | VR_{SKnee} | [] | |
| Rs-Vds Bias Expansion Factor | KR_{sL} | [] | |
| Rs-Vgs Bias Expansion Factor | KR_{sK} | [] | |
| Rs-Vds Bias Expansion Factor @ Rs Saturation | KR_{sSat} | [] | |
| Rs Bias Shaping Factor | γ^{R}s | [] | |

The following equations describe the drain access.

| | | | |
|---|---|---|---|
| Drain Access Resistance | R_{D} | [Ω] | = (R_{DRF} + R_{DN}) |
| | | | = (R_{DAccess} + R_{DundepCap} + R_{DundepRec} + R_{DSaturated})/W_{g} |
| Drain Access Resistance, except for recess access | R_{DRF} | [Ω] | − R_{DN} |
| Drain Recess Access Resistance | R_{DN} | [Ω] | = (R_{DRec})/W_{g} |
| | | | = R_{DdepRec}^{ON} (MR_{d} * V_{gs + 1) [1 -} |
| Drain Access Resistance: Recess snd Undepleted Cap | R_{DAccess} | [Ω * μ^{m}] | tanh{KR_{dseeK} * [V_{gs} − VR_{dOn} + V_{ds} * MR_{daccL}]}]/2 |
| | | | = R_{cont}RF_{rconF} + R_{SH}[D_{gd} |
| Drain Access Resistance Channel and Cap | R_{D undepCap} | [Ω * μ^{m}] | − REC_{gd} + L_{g}/2)] |
| Resistance of the Undepleted Drain Recess Access Region | R_{D undepRec} | [Ω * μ^{m]} | = R_{SHundep} (REC_{gd}) |
| | | | = MR_{dSat} * V_{ds}exp { − [V_{gs} + V_{ds} * MR_{dL} + VR_{DSatOff}]²/ (2 |
| Resistance of the Saturated Drain Recess Access region | R_{DSaturated} | [Ω * μ^{m}] | |
| Resistance of the Drain Recess Access region at high on-state | R_{D depRec}^{ON} | [Ω * μ^{m}] | =R_{SHdep} (REC_{gd}) |
| bias (Vₒₙ) | | | |
| | | | = δvl {1 + (R_{DAccess} − R_{DundepCap})/(²δvl) + sqrt[δ² |
| | R_{DRec} | [Ω * μ^{m}] | +((R_{DAccess} − R_{DundepCap})/(²δvl) − 1)²]} |
| Drain Access Resistance Bias Modification Factor | MR_{d} | [] | |
| Rd-Vds Access Bias Modification Factor | MR_{daccL} | [] | |
| Rd-Vgs Swith point to On-state | VR_{dOn} | [] | |
| Rd-Vgs Swith point at saturation | VR_{dSat} | [] | |
| Rdaccess-Vgs Bias Expansion Factor | KR_{daccK} | [] | |
| Rd-Vds Saturation Bias Modification Factor | MR_{dSat} | [] | |
| Rd-Vds Access Resistance Bias Modification Factor | MR_{dL} | [] | |
| Rd-Vgs Saturation Swith point to Off-state | VR_{dSatOff} | [] | |
| Rd-Vgs Saturation Swith point | VR_{dSat} | [] | |
| Rd-Vgs Saturation Swith point transition width | VR_{dSat}_{_{σ}} | [] | |
| Rd Bias Shaping Factor | γ^{R}d | [] | |

### Semi-Physical Determination of Small-Signal Equivalent Circuits

To derive values for the familiar small signal equivalent circuit as shown in FIG. 5, a small signal excitation analysis must be applied to the semi-physically modeled physical expressions. The method of applying such an analysis is as follows:

1) Gate Terminal Voltage Excitation

a) Apply a small+/−voltage delta around the desired bias condition, across the gate-source terminals.

b) Equivalent circuit element Gm=delta(Ids)/delta (Vgs') where delta (Vgs') is mostly the applied voltage deltas, but also subtracting out that voltage which is dropped across the gate source access region, shown as RsCont, RsundepCap, RsundepRec, ResdepRec, and RsBoundary in FIG. 12, above.

c) Equivalent circuit element Cgs and Cgd takes the form of delta(Nsn)/delta(Vgs)*Lgn, where delta (Nsn) is the appropriate charge control expression, and Lgn is the gate source or gate drain charge partitioning boundary length.

d) Equivalent circuit element Ri=Lgs/(Cgschannel*vs) where Cgs channel is the portion of gate source capacitance attributed to the channel only, and vs is the saturated electron velocity.

2) Drain Terminal Voltage Excitation

a) Apply a small +/−voltage delta around te same bias condition as in 1, but the delta is applied across drain source terminals.

b) Equivalent circuit element Rds=1/{delta(Ids)/delta(Vds')} where Vds' is mostly the applied voltage deltas, but also subtracting out voltage which is dropped over both the gate source and gate drain access regions.

c) Equivalent circuit element Cds is taken to be the sum of the appropriate fringing capacitance Semi-Physical models, or can take the form of delta(Nsd)/delta(Vds')*Xsat, were Nsd is the charge control expression for charge accumulation between the appropriate source and drain charge boundaries, and Xsat is the length of the saturated region, if in saturation.

3) On-mesa Parasitic Elements: The equivalent circuit elements, Rs and Rd are expressed by the appropriate electrical conduction models of the source and drain access regions.

The RF performance can be predicted at an arbitrary bias point.

Table 3 represents a comparison of the values for a high frequency equivalent circuit model derived from equivalent circuit model extraction from and semi-physical modeling for the sample illustrated in Table 2.

TABLE 2
Comparison of Modeled Equivalent Circuit Results for Semi-physical
Modeling Method, and Equivalent Circuit Model Extraction

| Intrinsic Equivalent | Equivalent Circuit | Semi-Physical |
|---|---|---|
| Circuit Parameter | Model | Device Model |
| Cgs | 0.227745 pF | 0.182 pF |
| Rgs | 64242 Ω | infinite Ω |
| Cgd | 0.017019 pF | 0.020 pF |
| Rgd | 133450 Ω | infinite Ω |
| Cds | 0.047544 pF | 0.033 pF |
| Rds | 160.1791 Ω | 178.1 Ω |
| Gm | 135.7568 mS | 124 mS |
| Ri | 3.034 Ω | 2.553 Ω |
| Tau | 0.443867 pS | 0.33 pS |

The results of the semi-physical modeling method produce a small-signal equivalent circuit values which are relatively more accurate than the physical device simulator in this case. Furthermore, given the differences in the parasitic embedding, treatment of the two approaches, the results given in Table 2 yield much closer results than a comparison of equivalent circuit values.

Table 3 lists the values of parasitic elements used in the model derivations. An important difference between the extracted equivalent circuit model and the semi-physically derived one is the use of Cpg and Cpd to model the effect of launch capacitance for the tested structure. This difference leads to the results of the extracted model results being slightly off from the optimum physically significant solution.

TABLE 3
Comparison of Modeled “Parasitic” Equivalent Circuit Results for Semi-
physical Modeling Method, and Equivalent Circuit Model Extraction

| Extrinsic Equivalent | Equivalent | Semi-Physical |
|---|---|---|
| Circuit Parameter | Circuit Model | Device Model |
| Rg | 1.678 Ω | 1.7 Ω |
| Lg | 0.029314 nH | 0.03 nH |
| Rs | 1.7 Ω | 1.21 Ω |
| Ls | 0.002104 nH | 0.003 nH |
| Rd | 3.309899 Ω | 5.07 Ω |
| Ld | 0.031671 nH | 0.02 nH |
| Cpg | 0 pF | 0.02 pF |
| Cpd | 0 pF | 0.01 pF |

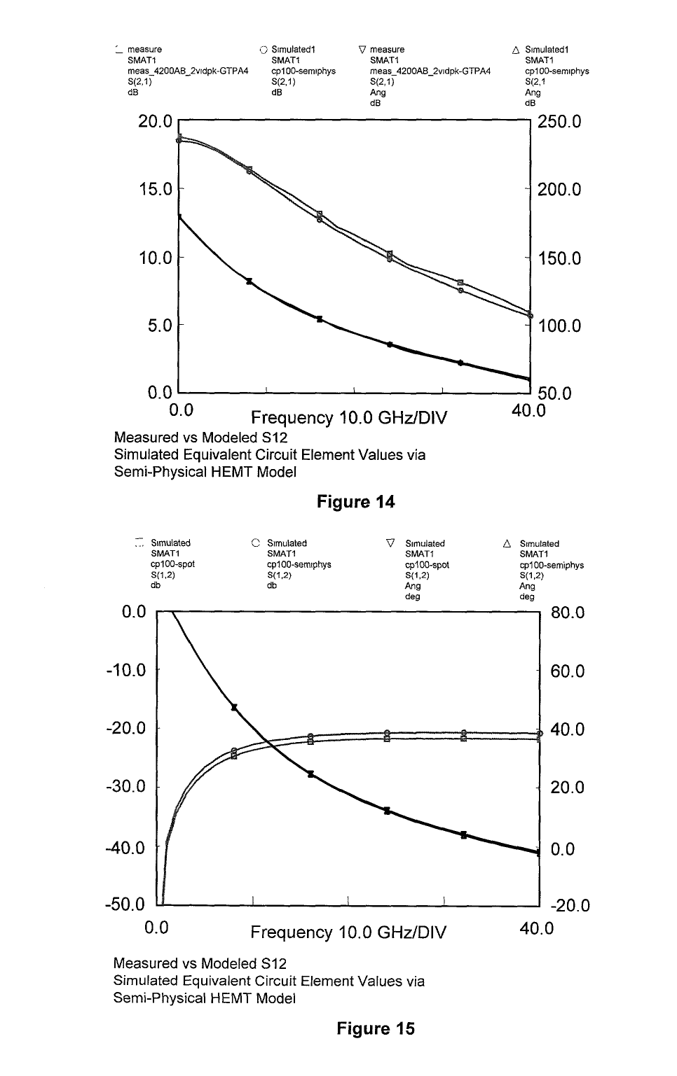

As shown in FIGS. 13, 14 and 15, the modeled results that are simulated using the semi-physically derived equivalent circuit model very accurately replicate the measured high frequency, S-parameter data.

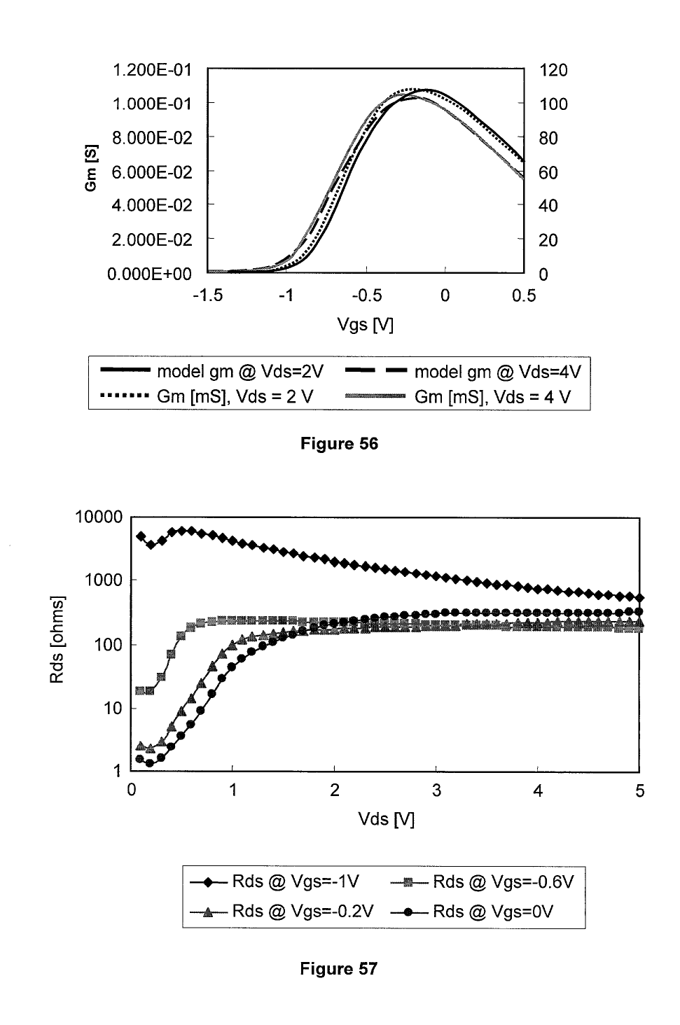

The following equations represent the small-signal excitation derivation of small-signal equivalent circuit modeled Gm. FIG. 56 illustrates the semi-physically simulated bias equations of the small signal Gm compared to measured date.

| | | | |
|---|---|---|---|
| Semi-Physically Modeled Drain-Source Current Control | I_{ds} | [A] | = g_{ch} V_{ds} (1 + λV_{ds})/ |
| | | | [1 + (V_{ds}/Vₛₐₜₑ)^{m}]^{1/m} |
| Small-Signal Deterimination of equiv. Circuit Gm value | g_{mRF} | [S] | = dl_{ds}/d(V_{gs} − V_{sAcc}) |
| | | | = I_{dsW} * (R_{SUndepCap} + R_{SAccess} + RSBoundary + |
| Source-Access voltage drop | V_{SAcc} | [V] | R_{probeS}/W_{g}) |
| Fine Extrinsic Saturation Voltage | Vₛₐₜₑ | [V] | = I_{satcom}/g_{ch} |
| | | | = g_{chi}/ |
| Extrinsic Conductance of the Linear Region, Under the gate | g_{ch} | [S] | [1 + g_{chi}(Rₛ + R_{d})] |
| Intrinsic Conductance of the Linear Region, Under the gate | g_{chi} | [S] | = (q Nₛ ^{μ}ₐᵥₑ W_{g})/L_{g} |

The following equations represent the small-signal excitation derivation of Rds. FIG. 57 illustrates the semi-physically simulated bias-dependence of the small-signal Rds.

| | | | |
|---|---|---|---|
| Small-Signal Deterimination of equiv. Circuit Rds value | R_{ds} | [Ω] | = 1/g_{dsRF} |
| | | | ={dI_{ds}/d(V_{ds} − R_{probeD} · I_{ds} − V_{sAcc}− V_{dAcc - VdSat} |
| | g_{dsRF} | [S] | } * r_{dsF} |
| | | | = I_{dsW * (R}_{DUndepCap} + R_{DUndepRec + R}_{DAccess +} |
| Drain-Access voltage drop | V_{DAcc} | [V] | R_{probeD}/W_{g}) |
| Drain-Saturated Region voltage drop | V_{DSAT} | [V] | = I_{dsW} * (R_{DSaturated}) |
| External Test probe or lead resistance | R_{probeD} | [Ω] | = (RF_{rdsF} + 1) * |
| High Frequency conductance dispersion factor | r_{dsF} | [] | tanh (10 * \|V_{ds} − Vₜₕ \|) + 1 |
| High Frequency conductance dispersion | RF_{rdsF} | [] | |

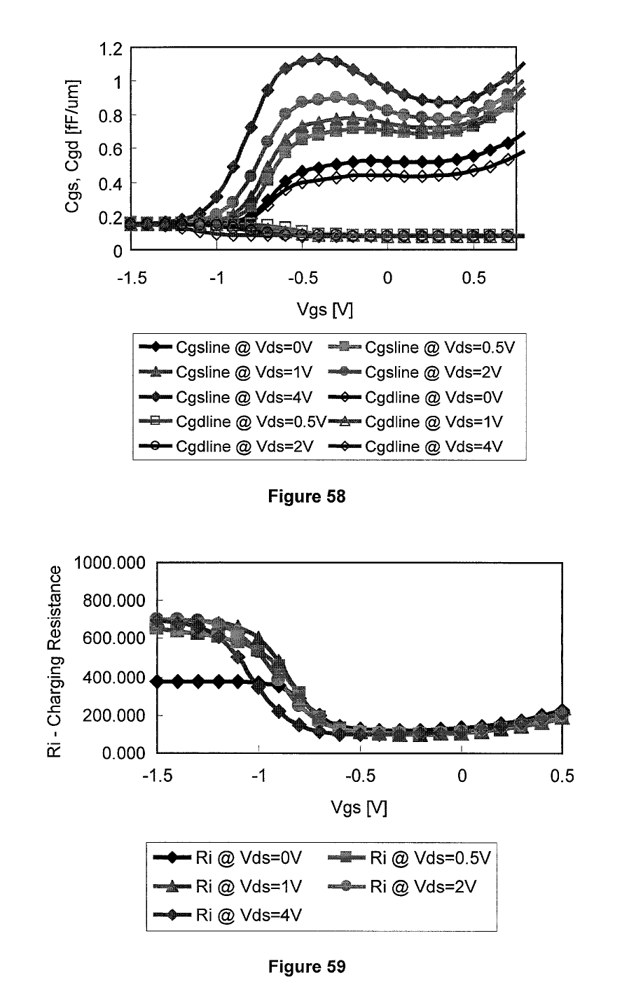

The following equations may be used for illustrating small-signal excitation derivation of Cgs and Cgd. FIG. 58 illustrates the Semi-Physically simulated bias-dependence of the small-signal Cgs and Cgd.

| | | | |
|---|---|---|---|
| Small-Signal Deterimination of equiv. Circuit Cgs value | C_{gs} | [fF/_{μ}m] | = C_{gsf} + _{β} C_{gcTot} L_{gs} · |
| | | | {1 − [(Vₛₐₜₑₙ − V_{dse})/(2 * Vₛₐₜₑₙ − V_{dse})]²} |
| | | | = C_{gdf} + _{β} C_{gcTot} L_{gd} * |
| | C_{gd} | [fF/_{μ}m] | {1 − [Vₛₐₜₑₙ/(2 * Vₛₐₜₑₙ −V_{dse})]²} |
| Parasitic Gate-Source Fringing Capacitance | C_{gsf} | [fF/_{μ}m] | = Cg_{surf} C_{f-form1}SiNF + Cgsf_{Source} + Cgsf_{Pad} |
| Parasitic Gate-Source Fringing Capacitance | C_{gdf} | [fF/_{μ}m] | = Cg_{surf} C_{f-form1}SiNF + Cgdf_{Cap} + Cgdf_{Pad} |
| Total Specific Gate-Channel Capacitance | C_{gcTot} | [fF/_{μ}m²] | = C_{gc} + C_{gcdonor} |
| | | | =c_{gc} Msh_{Kchan}/ |
| Specific Gate-Channel Capacitance | C_{gc} | [fF/_{μ}m²] | {[1 + (Nₛ′/(N₀ + N_{max0c})^{c})^{(1 + 1/γc)}]} |
| Effective Drain-Source Voltage Control | V_{dse} | [V] | =V_{ds}/[1 + (V_{ds}/Vₛₐₜₑₙ)^{m}]^{1/m} |
| Specific Gate-Donor Layer Accumulation Capacitance | C_{gcdonor} | [fF/_{μ}m²] | =q dN_{sDonor}/DV_{gs} |
| Ideal Specific Gate-Channel Capacitance | c_{gc} | [fF/_{μ}m²] | = q dNₛ′/dV_{gs} |
| | | | = Nₛ′ + Nₛ) * (dᵢ +^{Δ}dᵢ) Msh_{Kpar} * V_{gte}/ |
| Empirical Parasitic Donor Charge Control Expression | N_{sDonor} | [cm⁻²] | (dᵢ + ^{Δ}dᵢ) |
| Fringing capacitance to surface of source-access region | C_{gsurf} | [fF/_{μ}m] | |
| Empirical Fringing capacitance-bias shaping expression | C_{f-form1} | [] | = {1 − tanh[KC_{fK}(V_{gs} − VC_{fOn} + V_{ds}MC_{fL})]}/2 |
| Fringing capacitance to source-access region | C_{gsfSource} | [fF/_{μ}m] | |
| Fringing capacitance to source metal pads | C_{gsfPad} | [fF/_{μ}m] | |
| Fringing capacitance to drain-access Capped Region | C_{gdfCap} | [fF/_{μ}m] | |
| Fringing capacitance to drain metal pads | C_{gdfPad} | [fF/_{μ}m] | |
| Dielectric Coating Thickness Factor | SiNF | [] | |
| Specific Gate-Channel Capacitance Bias Modification Factor | Msh_{Kcahn} | [] | |
| Donor Charge Bias Modification Factor | Msh_{Kpar} | [] | |
| Empirical Specific Charge Control Shaping Parameter | γ^{C} | [] | |

The following equations are involved in the small-signal excitation derivation of Ri. FIG. 59 which follows shows the Semi-Physically simulated bias-dependence of the small-signal Ri.

| | | | |
|---|---|---|---|
| Gate-Source Non-quasistatic charging resistance | R_{iCharge} | [Ω * μ^{m}] | = L_{gs2} W_{g}/[C_{gsChan} W_{g}Vₛ] |
| | | | = C_{gsf} + _{β}C_{gc} L_{gs} * |
| Gate-Channel Source Capacitance | C_{gsChan} | [fF/_{μ}m] | {1 − [Vₛₐₜₑₙ − V_{dse})/(2 * Vₛₐₜₑₙ − V_{dse})]²} |

### Example of Semi-Physical Model and Bias Dependence Small Signal Source and Drain Resistance, Rs and Rd

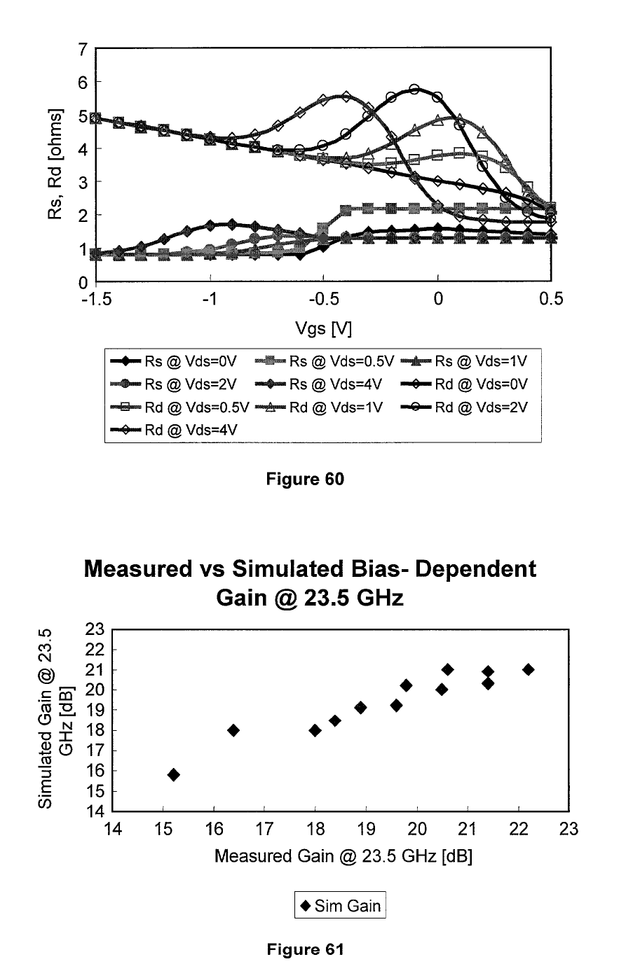

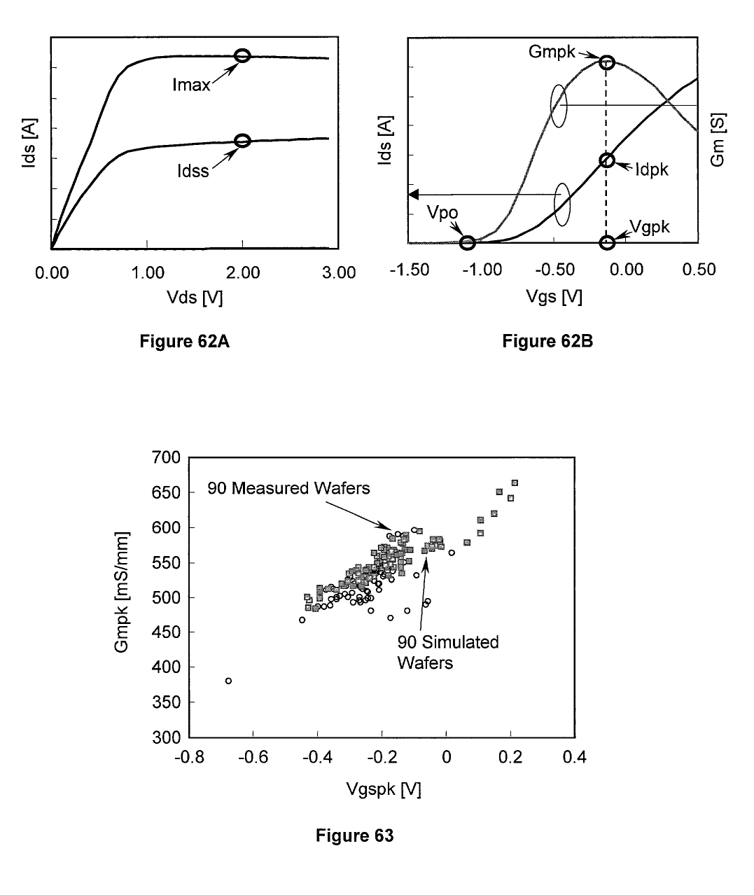

FIG. 60 shows the semi-physically simulated bias dependence of the on-mesa parasitic access resistances Rs and Rd.

The following example verifies how the semi-physical small-signal device model is able to provide accurate projections for bias-dependent small-signal performance. In this example, the same semi-physical device model as used in the previous examples was used because the example MMIC circuit was fabricated utilizing the same HEMT device technology.

In this example, the bias-dependence small-signal gain and noise performance of a two-stage balanced K-band MMIC LNA amplifier is replicated through microwave circuit simulation using small signal and noise equivalent circuits that were generated by the semi-physical model. The results of the measured and modeled results are shown below in Table 4. As seen from these results, the Semi-Physical device model was able to accurately simulate the measured bias-dependent performance, even though the bias variation was quite wide.

TABLE 4
Measured vs Modeled NF and Gain @ 23.5 GHz for a K-band MMIC
LNA at different bias conditions.

| | Measured | Predicted | Predicted | Measured |
|---|---|---|---|---|
| | Gain | Gain | NF | NF @ 23.5 |
| Bias Condition | @ 23.5 GHz | @ 23.5 GHz | @ 23.5 GHz | GHz |
| Vds = 0.5 V | 15.2 dB | 15.8 dB | 2.97 dB | 2.77 dB |
| 112 mA/mm | | | | |
| Vds = 1.0 V | 20.6 dB | 21.0 dB | 2.29 dB | 2.20 dB |
| 112 mA/mm | | | | |
| Vds = 2.0 V | 19.8 dB | 20.2 dB | 2.25 dB | 2.15 dB |
| 112 mA/mm | | | | |
| Vds = 3.0 V | 18.9 dB | 19.1 dB | 2.30 dB | 2.11 dB |
| 112 mA/mm | | | | |
| Vds = 3.5 V | 18.4 dB | 18.5 dB | 2.34 dB | 2.18 dB |
| 112 mA/mm | | | | |
| Vds = 4.0 V | 18.0 dB | 18.0 dB | 2.37 dB | 2.27 dB |
| 112 mA/mm | | | | |
| Vds 2.0 V | 16.4 dB | 18.0 dB | 2.45 dB | 2.21 dB |
| 56 mA/mm | | | | |
| Vds 2.0 V | 21.4 dB | 20.9 dB | 2.38 dB | 2.21 dB |
| 170 mA/mm | | | | |
| Vds = 2.0 V | 22.2 dB | 21.0 dB | 2.65 dB | 2.6 dB |
| 225 mA/mm | | | | |
| Vds = 3.0 V | 21.4 dB | 20.3 dB | 2.71 dB | 2.61 dB |
| 225 mA/mm | | | | |
| Vds = 3.0 V | 20.5 dB | 20.0 dB | 2.42 dB | 2.22 dB |
| 170 mA/mm | | | | |
| Vds 4.0 V | 19.6 dB | 19.2 dB | 2.50 dB | 2.29 dB |
| 170 mA/mm | | | | |

A plot of measured vs modeled gain for the values listed in Table 3 above is shown in FIG. 61.

The following example verifies how the Semi-Physical small-signal device model is able to provide accurate projections for physically dependent small-signal performance. In this example, the same Semi-Physical device model as used in the previous examples was used.

In this example, physical process variation was input into the Semi-Physical device model in terms of statistical variation about known averages, cross-correlation, and standard deviations. The goal of this exercise was to replicate the measured DC and small-signal device variation. The degree of accurate replication indicates the degree to which the Semi-Physical model is physically accurate.

Table 5 below lists the simulated, and known process variation that was used:

TABLE 5
Statistical process variation model

| Parameter | Nominal | | Standard Dev. | |
|---|---|---|---|---|
| Gate Length | 0.15 | μm | 0.01 | μm |
| Gate-Source Recess | 0.16 | μm | 0.015 | μm |
| Gate-Drain Recess | 0.24 | μm | 0.020 | μm |
| Etch Depth | 780 | A | 25 | A |
| Pass. Nitride Thickness | 750 | A | 25 | A |
| Gate-Source Spacing | 0.7 | μm | 0.1 | μm |
| Source-Drain Spacing | 1.8 | μm | 0.15 | μm |

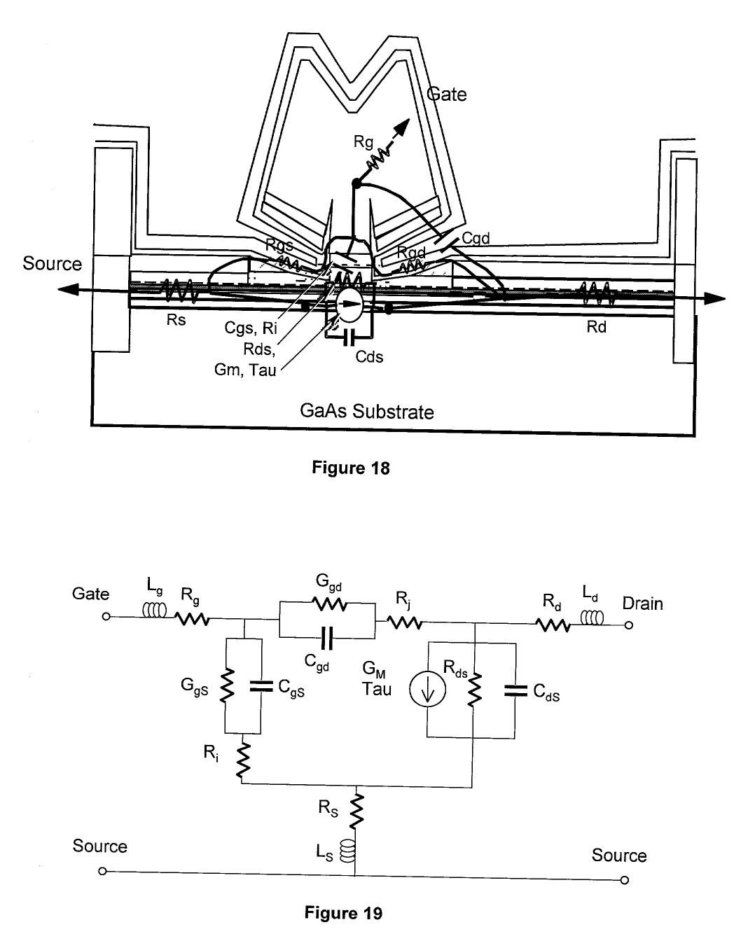

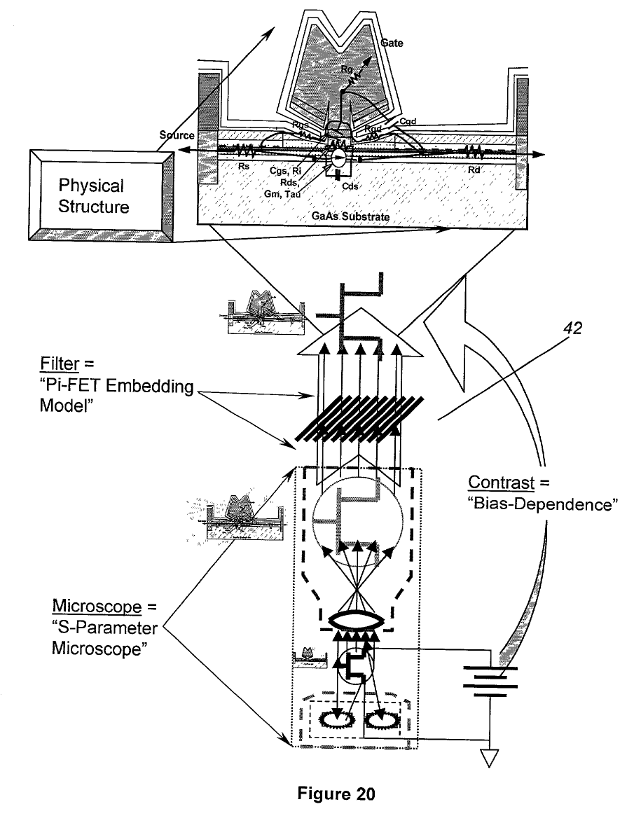

In the course of microelectronic component production, sample devices are tested in process in order to gain statistical process control monitor (PCM) data. FIG. 18 shows schematically the kind of data that is extracted and recorded from measured device I-V's during PCM testing.

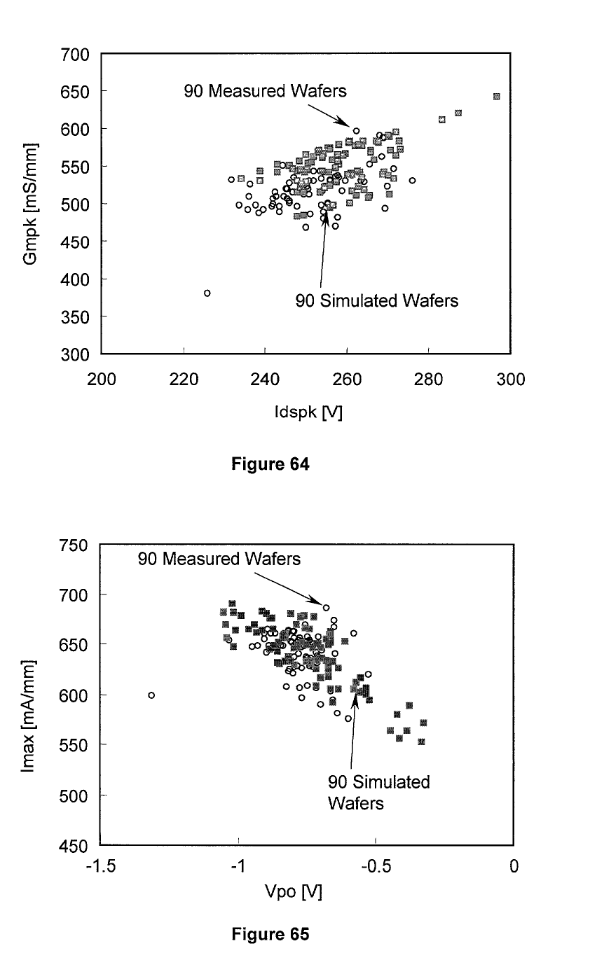

Since the Semi-Physical device model is able to simulate I-V's, it was able to simulate to variation of I-V's due to physical process variation. These I-V's were analyzed in the same fashion to extract the same parameters that are recorded for PCM testing. FIGS. 63, 64 AND 65 shows how accurately the simulated results match with measured process variation. FIG. 63 shows how the Semi-Physically simulated Vgpk and Gmpk match with actual production measurements. FIG. 64 shows how simulated Idpk and Gmpk match, also. Finally, FIG. 65 shows how simulated Imax and Vpo also match very well.

Small-signal S-parameter measurements are also taken in process for process control monitoring. These measurements are used to extract simple equivalent circuit models that fit the measured S-parameters. Since the Semi-Physical device model is able to simulate these equivalent circuit models, it was able to simulate the variation of model parameters due to physical process variation.

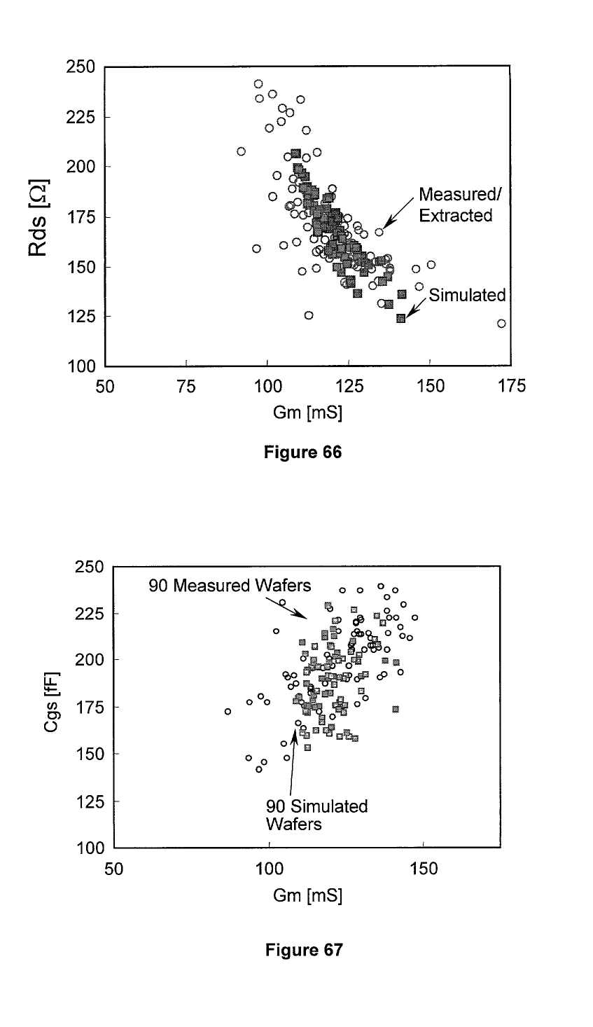

FIGS. 66 and 67 show how accurately the simulated results match with measured/extracted process variation for the small-signal model parameters. FIG. 66 shows how the Semi-Physically simulated Rds and Gm match very well with actual extracted model process variation.

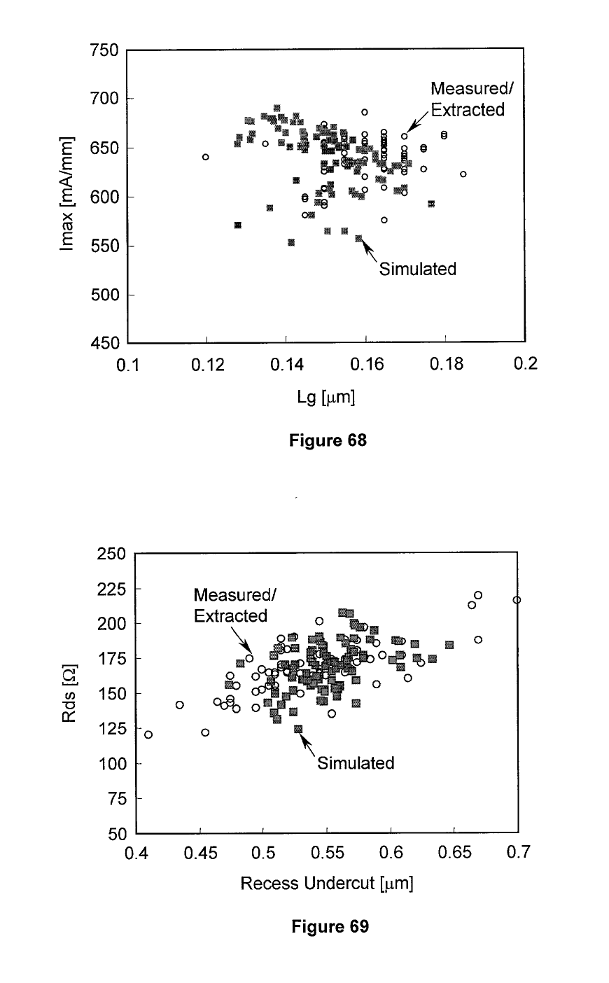

More direct and convincing evidence supporting the accurate, physical nature of the Semi-Physical model can be shown be comparing the dependence of simulated and measured performance to real physical variable. As shown in FIG. 68, the Semi-Physical model is able to very accurately reproduce the dependence of Imax upon gate length. In addition, the Semi-Physical model is also able to replicate physical dependence for high-frequency small-signal equivalent circuits. This is shown in FIG. 69, which shows that it is able to reproduce the dependence of Rds with Recess undercut width.

### S-Parameter Microscopy

The S-parameter (SPM) method utilizes bias dependent S-parameter measurements as a form of microscopy to provide qualitative analysis of the internal charge and electrical field structure of the semiconductor device heretofore unknown. Pseudo images are gathered in the form of S-parameter measurements extracted as small signal models to form charge control maps. Although finite element device simulations have heretofore been used to calculate the internal charge/electric field of semiconductor devices, such methods are known to be relatively inaccurate. The S-parameter microscopy provides a relatively accurate method for determining the internal charge and electric field within a semiconductor device. With accurate modeling of the internal charge and electric field, all of the external electrical characteristics of semiconductor devices can be relatively accurately modeled including its high frequency performance. Thus, the system is suitable for making device technology models that enabled high frequency MMIC yield analysis forecasting and design for manufacturing analysis.

S-parameter microscopy is similar to other microscopy techniques in that SPM utilizes measurements of energy reflected to and from a sample to derive information. More particularly, SPM is based on transmitted and reflective microwave and millimeter wave electromagnetic power or S-parameters. As such, S-parameter microscopy is analogous to the combined operation of scanning and transmission electron microscopes (SEM and TEM). Scattered RF energy is analogous to the reflection and transmission of the electron beams in the SEM and TEMs. However, instead of using electron detectors as in the SEM and TEMs, reflectometers in a network analyzer are used in S-parameter microscopy to measure a signal. S-parameter microscopy is similar to other microscopy techniques in that both utilize; measurement of scattering phenomenon as data; include mechanisms to focus measurements for better resolution; and include mechanisms to contrast portions of the measurement to discriminate detail as shown in Table 6 below:

TABLE 6

| General Microscopes | S-Parameter Microscope |
|---|---|
| Measure of scattered energy | Measures S-Parameters |
| Mechanism for “focus” | Focuses by extraction of Unique |
| | equivalent circuit models |
| Mechanism for “contrast” | Contrasts by using bias dependence to |
| | finely discriminate the nature and |
| | location of charge/electric fields |

Result: Detailed “Images” of Device's Internal Charge and Electric Field Structure.

Images as discussed herein, in connection with S-parameter microscopy do not relate to real images, but are used provide insight and qualitative detail regarding the internal operation of a device. More specifically, S-parameter microscopy does not provide visual images as in the case of traditional forms of microscopy. Rather, S-parameter microscopy images are more like maps which are computed and based on a non-intuitive set of measurements.

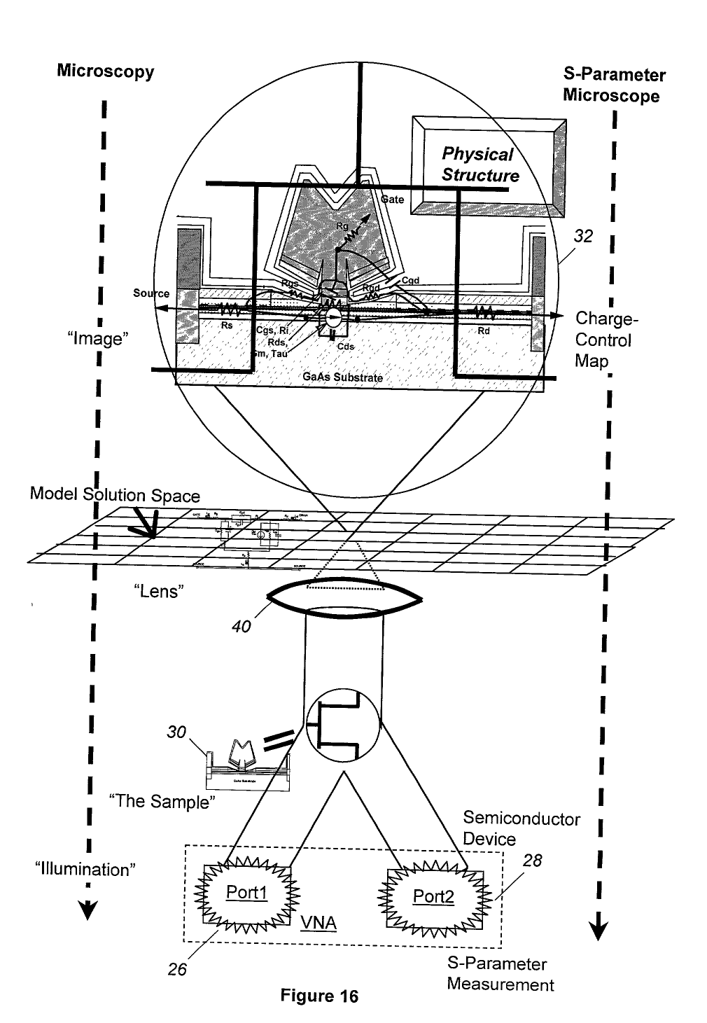

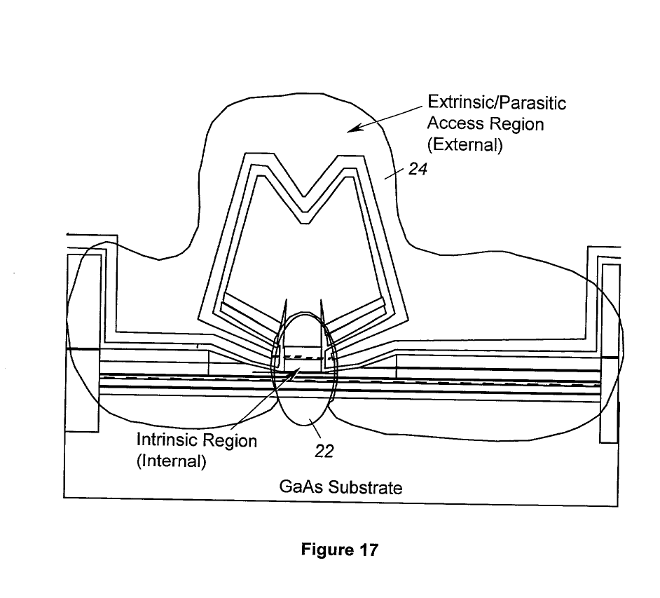

FIG. 16 illustrates a conceptual representation of an S-parameter microscope, generally identified with the reference numeral 20. The S-parameter microscope 20 is analogous to a microscope which combines the principles of SEM and TEM. Whereas SEM measures reflections and TEM measures transmissions, the 2-port S-parameter microscope 20 measures both reflective and transmitted power. As a result, data derived from the 2-port S-parameter microscope contains information about the intrinsic and extrinsic charge structure of a device. More particularly, as in known in the art, SEM provides relatively detailed images of the surface of a sample through reflected electrons while TEM provides images of the internal structure through transmitted electrons. The reflective signals are used to form the external details of a sample while transmitted electrons provide information about the interior structure of a device. In accordance with an important aspect of the invention, S-parameter microscopy utilizes a process of measuring reflective and transmitted signals to provide similar “images” of the charge structure of a semiconductor device. As used herein the internal and external electrical structure of a semiconductor device are commonly referred to as intrinsic device region 22 and extrinsic parasitic access region 24 as shown in FIG. 17. Also contributing to the external electrical structure of the device are parasitic components associated with the electrodes and interconnects which are not shown. These are the so-called device “layout parasitics”.

Referring to FIG. 16, the ports 26 and 28 are emulated by S-parameter measurements. The S-parameter measurements for a specific semiconductor device, generally identified with the reference number 30, are processed to provide charge control maps, shown within the circle 32, analogous to images in other microscopy techniques. These charge control maps 32, as will be discussed in more detail below, are expressed in the form of equivalent circuit models. As shown in FIG. 18, linear circuit elements are used in the models to represent the magnitude and state of charge/electric fields inside the semiconductor device 30 or its so-called internal electrical structure. The position of the circuit elements within the model topology is roughly approximate the physical location within the device structure, hence the charge control map represents a diagram of the device's internal electrical structure.

The interpretation of the exact location of measured charge/electric fields within the semiconductor device is known to be ambiguous since an equivalent circuit model, for example, as illustrated in FIG. 19 with discrete linear elements, is used to represent the distributed structure of the charge/electric fields in the actual device. Although there is no exact method for distinguishing the physical boundaries between measured quantities, bias dependence is used to clarify how the S-parameters should be discriminated, separated and contrasted. In particular, changing bias conditions is known to change the magnitude and shift boundaries between the charge and electric fields within the device. The changes are normally predictable and qualitatively well known in most technologies. As such, the charge control maps can readily be used as maps illustrating the characterization of physical changes in magnitude, location and separation of electric charge and electric fields.

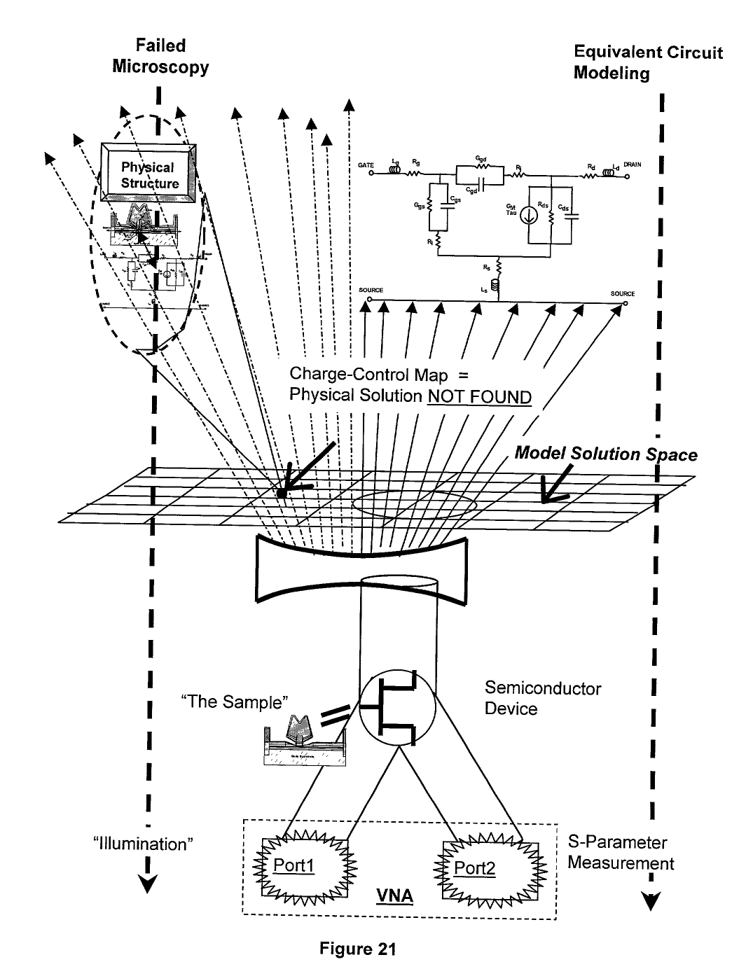

Analogous to other forms of microscopy, the S-parameter microscope 20 in accordance with the present invention also emulates a lens, identified with the reference numeral 40 (FIG. 16). The lens 40 is simulated by a method for the extraction of a unique equivalent circuit model that also accurately simulates the measured S-parameter. More particularly, parameter extraction methods for equivalent circuit models that simulate S-parameters are relatively well known. However, when the only goal is accurately fitting measuring S-parameters, an infinite number of solutions exist for possible equivalent circuit parameter values. Thus, in accordance with an important aspect of the present invention, only a single unique solution is extracted which accurately describes the physical charge control map of the device. This method for unique extraction of equivalent circuit model parameters acts as a lens for focus the charge control map solution. As discussed and illustrated herein, the lens 40 is subsequently simulated by a filter that is based on an apparent layout parasitic embedding model. As discussed below, the layout parasitic embedding model consists of linear elements which simulate the effect of the device's electrodes and interconnects upon its external electrical characteristics. A Pi FET embedding model 42, is described below. This model effectively acts as a filter to remove the electrical structure of the extrinsic parasitic access contribution to the preliminary charge control map solution. The resultant, filtered charge control map solution represents a clearer “image”, which shows only the electrical structure of the intrinsic device. This enhanced imaging is needed in order to achieve as accurate a view of the internal electric charge/field as possible. Unlike conventional extraction techniques as illustrated in FIG. 21, which can only extract equivalent non-unique circuit models and not the unique charge control map, the S-parameter microscope 20 in accordance with the present invention is able to relatively accurately model the internal electric charge/field structure within a semiconductor device.

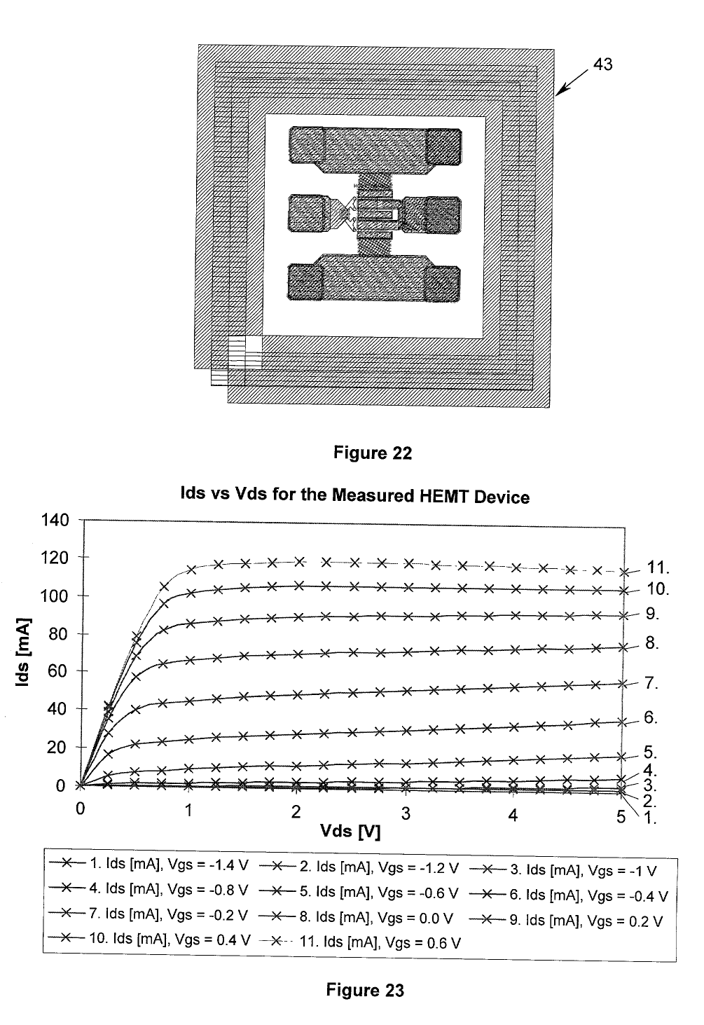

An exemplary application of the S-parameter microscope is illustrated in detail below. In this example, an exemplary GaAs HEMT device with four gate fingers and 200 μm total gate periphery formed in a Pi-FET layout as generally illustrated in FIG. 22 and identified with the reference numeral 43 is used. The GaAs HEMT 43 is adapted to be embedded in a 100-μm pitch coplanar test structure to facilitate on wafer S-parameter measurement.

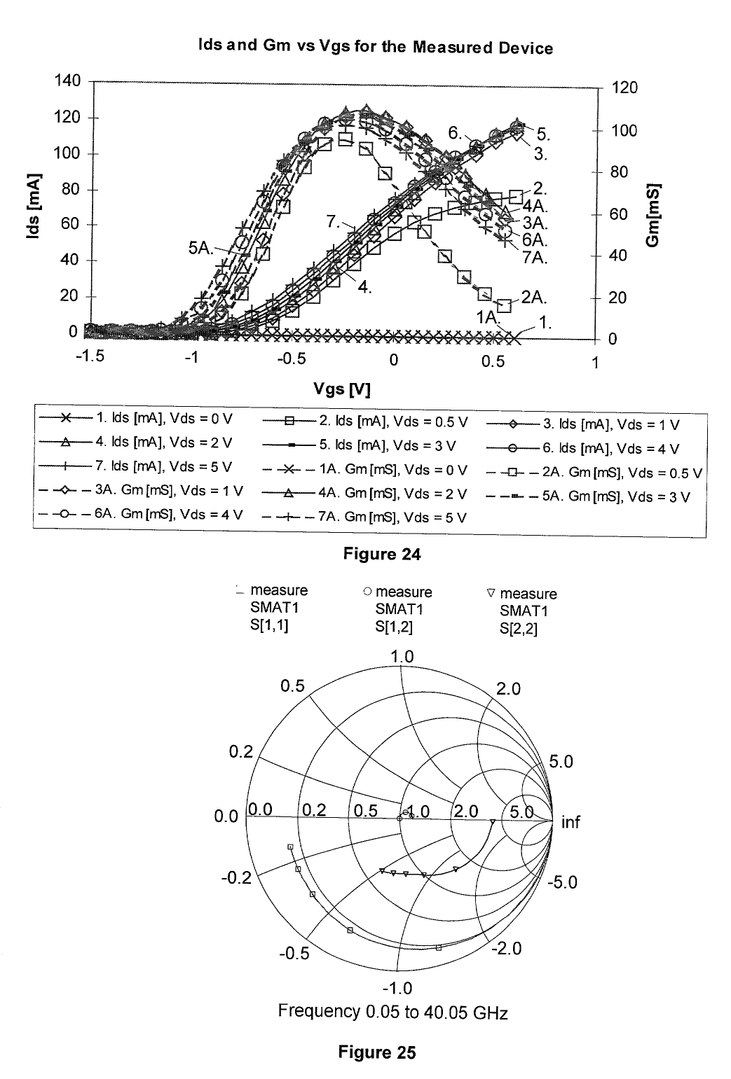

Initially, as illustrated in FIGS. 23 and 24, the I-V characteristics for the device are measured. In particular, the drain source current Ids is plotted as a function of drain-to-source voltage V_{ds} at various gate voltages Vgs as shown in FIG. 23. and FIG. 24 illustrates the drain-to-source current Ids as a function of gate voltage Vgs and transconductance Gm (i.e. the derivative of Ids with respect to Vgs) at different drain voltages Vds. These I-V characteristics are typical of HEMT devices and most semiconductor devices, which are one type of three-terminal semiconductor device technology.

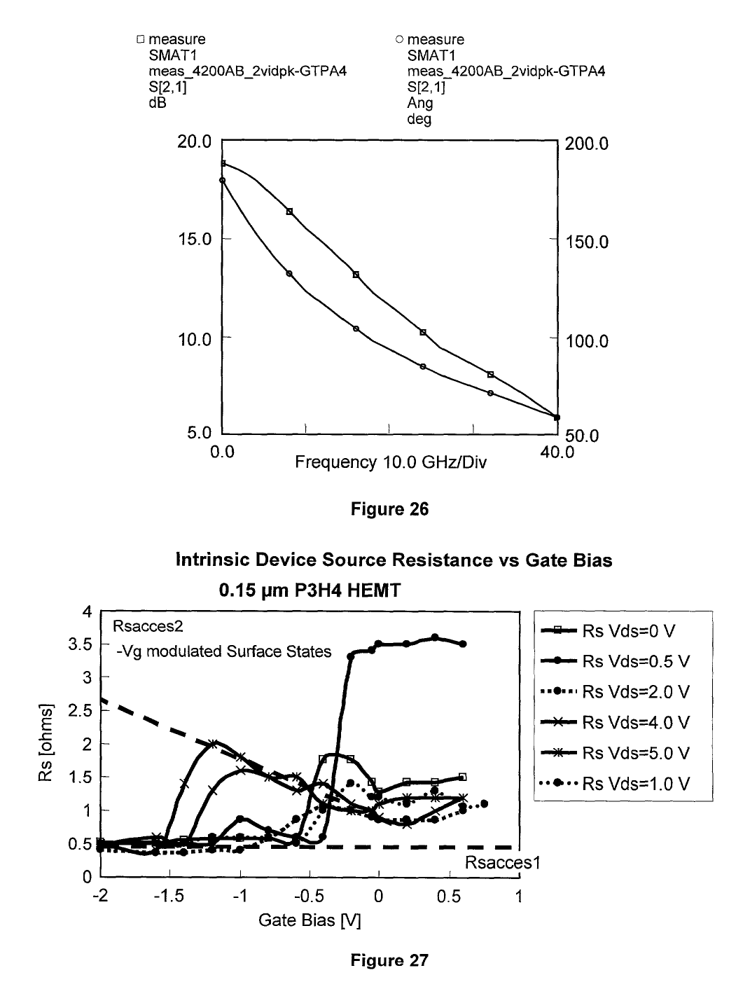

Table 7 shows the bias conditions in which S-parameters were measured. The S-parameters were measured from 0.05 to 40 GHz at each bias condition. FIG. 25 illustrates a Smith chart illustrating the measured S-parameters S11, S12 and S22 for frequencies from 0.05 to 40.0 GHz. FIG. 26 is a graphical illustration of magnitude as a function of angles for the measured S-parameter S21 for frequencies from 40.05 to 40.0 GHz.

TABLE 7
Measured S-parameter Bias Conditions

| Biases | Vds = | Vds = | Vds = | Vds = | Vds = | Vds = |
|---|---|---|---|---|---|---|
| Vgs | 0 V | 0.5 V | 1.0 V | 2.0 Y | 4.0 V | 5.0 V |
| −1.6 V | Yes | Yes | Yes | Yes | Yes | Yes |
| −1.4 V | Yes | Yes | Yes | Yes | Yes | Yes |
| −1.2 V | Yes | Yes | Yes | Yes | Yes | Yes |
| −1 V | Yes | Yes | Yes | Yes | Yes | Yes |
| −0.8 V | Yes | Yes | Yes | Yes | Yes | Yes |
| −0.6 V | Yes | Yes | Yes | Yes | Yes | Yes |
| −0.4 V | Yes | Yes | Yes | Yes | Yes | Yes |
| −0.2 V | Yes | Yes | Yes | Yes | Yes | Yes |
| 0 V | Yes | Yes | Yes | Yes | Yes | Yes |
| 0.2 V | Yes | Yes | Yes | Yes | Yes | Yes |
| 0.4 V | Yes | Yes | Yes | Yes | Yes | Yes |
| 0.6 V | Yes | Yes | Yes | Yes | Yes | Yes |

Using the small signal model illustrated in FIG. 19, the extracted small signal equivalent circuit values are obtained as illustrated in Table 8 for each S-parameter at each bias condition, using the extraction method discussed below

TABLE 8
Bias-dependent Small-signal Equivalent

| Vd | Vg | Rg + Ri | Rs | Rd | Lg | Ls | Ld | Cgs |
|---|---|---|---|---|---|---|---|---|
| [V] | [V] | [W] | [W] | [W] | [nH] | [nH] | [nH] | [pF] |
| 0 | −2 | 4.32849 | 0.5125 | 4.2 | 0.0197 | 0.00001 | 0.0265 | 0.0415 |
| 0 | −1.6 | 4.11231 | 0.52 | 4 | 0.028 | 0 | 0.0245 | 0.045 |
| 0 | −1.4 | 3.01231 | 0.55 | 3.5389 | 0.0275 | 0.00001 | 0.0234 | 0.0501 |
| 0 | −1.2 | 3.97956 | 0.5857 | 3.9231 | 0.0274 | 0.00001 | 0.0245 | 0.0549 |
| 0 | −1 | 3.67822 | 0.58 | 3.7 | 0.0263 | 0.00123 | 0.0253 | 0.6332 |
| 0 | −0.8 | 3.39996 | 0.58 | 3.6713 | 0.0262 | 0.00347 | 0.0259 | 0.0800 |
| 0 | −0.6 | 3.33401 | 0.5857 | 3.5031 | 0.0276 | 0.00353 | 0.0239 | 0.0923 |
| 0 | −0.4 | 3.31632 | 1.7677 | 3.3 | 0.0232 | 0.00356 | 0.0338 | 0.1002 |
| 0 | −0.2 | 3.09963 | 1.7677 | 3.3 | 0.0242 | 0.00347 | 0.0344 | 0.1044 |
| 0 | 0 | 3.16448 | 1.4142 | 3.5 | 0.0156 | 0.00334 | 0.0314 | 0.1076 |
| 0 | 0.2 | 2.45244 | 1.2803 | 3.3080 | 0.0266 | 0.00384 | 0.0281 | 0.1100 |
| 0 | 0.6 | 2.48828 | 1.4142 | 2.6195 | 0.0266 | 0.00352 | 0.0284 | 0.1247 |
| 0 | 0.755 | 4.31968 | 1.5 | 2.3 | 0.0188 | 0.00320 | 0.0308 | 0.1417 |
| 0.5 | −1.6 | 4.80961 | 0.5 | 4 | 0.0337 | 0.0 | 0.0169 | 0.0472 |
| 0.5 | −1.4 | 4.24223 | 0.5 | 3.5389 | 0.0281 | 0.0 | 0.0247 | 0.0517 |
| 0.5 | −1.2 | 3.91986 | 0.5 | 3.9231 | 0.0291 | 0.00030 | 0.0226 | 0.0592 |
| 0.5 | −1 | 3.25620 | 0.8535 | 3.7 | 0.0288 | 0.00354 | 0.0275 | 0.0726 |
| 0.5 | −0.8 | 3.22405 | 0.7 | 3.6713 | 0.0284 | 0.00319 | 0.0246 | 0.0907 |
| 0.5 | −0.6 | 2.78789 | 0.6 | 3.5031 | 0.0295 | 0.00337 | 0.0258 | 0.1015 |
| 0.5 | −0.4 | 1.71421 | 0.6 | 3.3 | 0.0305 | 0.00343 | 0.0252 | 0.0853 |
| 0.5 | −0.2 | 0.14250 | 3.3 | 3.3 | 0.0197 | 3.78E | 0.0230 | 0.1498 |
| 0.5 | 0 | 2.35912 | 3.4 | 3.4 | 0.0206 | 0.00373 | 0.0153 | 0.1688 |
| 0.5 | 0.2 | 1.38026 | 3.5 | 3.3080 | 0.0179 | 0.00563 | 0.0208 | 0.2136 |
| 0.5 | 0.4 | 1.56731 | 3.5 | 3.0026 | 0.0253 | 0.00556 | 0.0210 | 0.115 |
| 0.5 | 0.6 | 1.54964 | 3.6 | 2.6195 | 0.0345 | 0.00356 | 0.0274 | 0.219 |
| 1 | −1.6 | 0.04221 | 0.5 | 3.9 | 0.0376 | 0.00001 | 0.01 | 0.0470 |
| 1 | −1.4 | 5.37668 | 0.5 | 3.5312 | 0.0429 | 0.00070 | 0.01 | 0.0488 |
| 1 | −1.2 | 3.73022 | 0.6 | 4.3839 | 0.0263 | 0.0 | 0.0305 | 0.0625 |
| 1 | −1 | 2.83050 | 2.6 | 3.7 | 0.0313 | 0.0013 | 0.0274 | 0.0795 |
| 1 | −0.8 | 3.38450 | 0.6 | 3.3582 | 0.0289 | 0.00373 | 0.0254 | 0.1042 |
| 1 | −0.6 | 3.00864 | 0.5 | 2.6848 | 0.0297 | 0.00429 | 0.0266 | 0.1280 |
| 1 | −0.4 | 2.20164 | 1 | 5.2497 | 0.0320 | 0.00355 | 0.0246 | 0.1370 |
| 1 | −0.2 | 1.77701 | 1.4 | 6.1397 | 0.0321 | 0.00296 | 0.0237 | 0.1437 |
| 1 | 0 | 2.04598 | 1.2 | 3.7663 | 0.0320 | 0.00341 | 0.0263 | 0.1473 |
| 1 | 0.2 | 2.25956 | 1.1 | 0.6755 | 0.0303 | 0.00405 | 0.0297 | 0.1540 |
| 1 | 0.4 | 2.11654 | 1.4 | 1.2072 | 0.0302 | 0.00451 | 0.0276 | 0.1553 |
| 1 | 0.6 | 2.68064 | 1.0606 | 0.5321 | 0.0277 | 0.00522 | 0.0290 | 0.1502 |
| 2 | −1.6 | 4.21832 | 0.3661 | 3.6443 | 0.0216 | 0.00007 | 0.0271 | 0.0490 |
| 2 | −1.4 | 4.16045 | 0.3535 | 3.7828 | 0.0320 | 0.0 | 0.0098 | 0.0518 |
| 2 | −1.2 | | 0.4 | 3.3 | | | | |
| 2 | −1 | 3.97092 | 0.4 | 2.9573 | 0.0199 | 0.00355 | 0.0258 | 0.0885 |
| 2 | −0.8 | 3.43921 | 0.5857 | 3.0326 | 0.0217 | 0.00369 | 0.0268 | 0.1034 |
| 2 | −0.6 | 3.14409 | 0.8535 | 2.8295 | 0.0236 | 0.00351 | 0.0270 | 0.1551 |
| 2 | −0.4 | 2.61645 | 1.0606 | 4.4593 | 0.0246 | 0.00350 | 0.0266 | 0.1632 |
| 2 | −0.2 | 2.16237 | 1 | 5.6305 | 0.0255 | 0.00343 | 0.0252 | 0.1569 |
| 2 | −5.40E | 2.31075 | 0.9 | 5 | 0.0235 | 0.00358 | 0.0270 | 0.1535 |
| 2 | 0 | 2.09877 | 0.8535 | 4.7672 | 0.0255 | 0.00359 | 0.0253 | 0.1529 |
| 2 | 0.2 | 2.64301 | 0.8535 | 3.2348 | 0.0244 | 0.00356 | 0.0280 | 0.1572 |
| 2 | 0.4 | 3.03424 | 0.8535 | 1.8041 | 0.0234 | 0.00356 | 0.0290 | 0.1640 |
| 2 | 0.6 | 3.45639 | 1 | 0.6117 | 0.0224 | 0.00351 | 0.0280 | 0.1749 |
| 4 | −1.6 | 1 | 0.6 | 3.6 | 0.0390 | 0.00007 | 0.01 | 0.0476 |
| 4 | −1.4 | 4.71381 | 0.5 | 3.4379 | 0.0206 | 0.00014 | 0.0271 | 0.0593 |
| 4 | −1.2 | 4.42193 | 1.3 | 3.2 | 0.0271 | 0.00002 | 0.0012 | 0.0769 |
| 4 | −1 | 4.28211 | 1.6 | 3.1306 | 0.0222 | 0.00226 | 0.0251 | 0.1196 |
| 4 | −0.8 | 3.92452 | 1.5 | 3.0550 | 0.0233 | 0.00280 | 0.0266 | 0.1691 |
| 4 | −0.6 | 3.45589 | 1.3 | 3.8185 | 0.0243 | 0.00303 | 0.0252 | 0.1907 |
| 4 | −0.4 | 3.15713 | 1.4 | 5.5202 | 0.0254 | 0.00245 | 0.0223 | 0.1952 |
| 4 | −0.2 | 3.03221 | 1.1 | 3.8728 | 0.0248 | 0.00311 | 0.0263 | 0.1880 |
| 4 | 0 | 2.78474 | 1 | 2.7 | 0.0249 | 0.00425 | 0.0273 | 0.1750 |
| 4 | 0.2 | 3.24209 | 0.9 | 1.4899 | 0.0240 | 0.00381 | 0.0286 | 0.1787 |
| 4 | 0.4 | 3.99720 | 0.8 | 1.2 | 0.0203 | 0.00414 | 0.0209 | 0.2066 |
| 4 | 0.6 | 3.85544 | 1 | 1.1212 | 0.0233 | 0.00299 | 0.0231 | 0.1973 |
| 5 | −1.6 | 3.83032 | 0.4 | 3.6 | 0.0262 | 0.01559 | 0.0331 | 0.0480 |
| 5 | −1.4 | 4.28848 | 1.4 | 3.4 | 0.0217 | 0.0 | 0.0283 | 0.0633 |
| 5 | −1.2 | 4.21790 | 2 | 3.3 | 0.0153 | 0.00341 | 0.0235 | 0.0966 |
| 5 | −1 | 4.47178 | 1.8 | 2.8732 | 0.0223 | 0.00199 | 0.0252 | 0.1470 |
| 5 | −0.8 | 3.78294 | 1.5 | 3.4602 | 0.0236 | 0.00317 | 0.0243 | 0.1874 |
| 5 | −0.6 | 3.43996 | 1.5 | 5.2607 | 0.0246 | 0.00289 | 0.0216 | 0.2051 |
| 5 | −0.4 | 3.24864 | 1.1 | 3.4105 | 0.0242 | 0.00372 | 0.0245 | 0.2048 |
| 5 | −0.2 | 3.36600 | 1 | 2.4330 | 0.0241 | 0.00316 | 0.0267 | 0.2009 |
| 5 | 0 | 3.66823 | 1 | 1 | 0.0236 | 0.00238 | 0.0302 | 0.2016 |
| 5 | 0.2 | 3.60190 | 1.1 | 0.6014 | 0.0239 | 0.00260 | 0.0293 | 0.2008 |
| 5 | 0.4 | 4.21933 | 1.2 | 0.6 | 0.0230 | 0.00249 | 0.0282 | 0.2169 |
| 5 | 0.6 | 3.80536 | 1.2 | 0.5 | 0.0240 | 0.00292 | 0.0212 | 0.2107 |

| Cdg | Cds | Gm | Rds | Ta | Rgs | Rgd |
|---|---|---|---|---|---|---|
| [pF] | [pF] | [mS | [W] | [pS | [W] | [W] |
| 0.0415 | 0.0432 | 0 | 1000000 | 0 | 904000000 | 90400000 |
| 0.045 | 0.045 | 0 | 1000000 | 0 | 87000 | 87000 |
| 0.0501 | 0.046 | 0 | 1000000 | 0 | 70000 | 70000 |
| 0.0549 | 0.0467 | 0 | 3532.954 | 0 | 59895.6 | 59895.6 |
| 0.0632 | 0.047 | 0 | 200 | 0 | 60000 | 60000 |
| 0.0800 | 0.0488 | 0 | 51.8679 | 0 | 60000 | 60000 |
| 0.0923 | 0.1597 | 0 | 7.84388 | 0 | 970000000 | 97000000 |
| 0.1002 | 0.1805 | 0 | 6.65812 | 0 | 65565.93 | 65565.93 |
| 0.1044 | 0.4210 | 0 | 4.75859 | 0 | 58682.78 | 58682.78 |
| 0.1076 | 0.4583 | 0 | 3.49009 | 0 | 55000 | 55000 |
| 0.1100 | 1.6745 | 0 | 1.40002 | 0 | 16926.72 | 16926.72 |
| 0.1247 | 2.0290 | 0 | 1.25101 | 0 | 3811.933 | 3811.933 |
| 0.1417 | 2 | 0 | 2.94325 | 0 | 478.3791 | 478.3791 |
| 0.0389 | 0.0462 | 0.22 | 1.02E+08 | 0.1 | 100403 | 8.10E+07 |
| 0.0390 | 0.0444 | 0.5 | 1000000 | | | |
| 0.0398 | 0.0461 | 0.73 | 1.08E+08 | 0.6 | 24714.05 | 9.23E+07 |
| 0.0398 | 0.0458 | 5.67 | 7.00E+02 | 0.2 | 9.90E+07 | 98010 |
| 0.0425 | 0.0462 | 28.0 | 254.802 | 0.2 | 69641.32 | 69641.32 |
| 0.0458 | 0.0474 | 73.8 | 84.25923 | 0.1 | 16066.22 | 6.36E+07 |
| 0.0595 | 0.0669 | 107. | 38.90041 | 0.0 | 8.77E+07 | 77782.14 |
| 0.0570 | 0.3524 | 116 | 9.43176 | 0.0 | 18440.35 | 9.70E+07 |
| 0.0908 | 0.5 | 108 | 7 | 150 | 1.00E+08 | 1.00E+08 |
| 0.0401 | 1.4 | 100 | 1.45897 | 447 | 9915.727 | 1.00E+08 |
| 0.115 | 2 | 85 | 1.2 | 156 | 8630.088 | 9.90E+07 |
| 0.0115 | 2.1 | 75 | 1.4 | 0.0 | 28918.35 | 9.90E+07 |
| 0.0360 | 0.0471 | 0.03 | 1.03E+08 | 735 | 10980.53 | 1.02E+08 |
| 0.0363 | 0.0485 | 0.08 | 1.23E+08 | 0.1 | 71680.16 | 9.70E+07 |
| 0.0358 | 0.0455 | 1.39 | 1.03E+08 | 0.8 | 42870.63 | 1.00E+08 |
| 0.0343 | 0.0472 | 8.76 | 6.96E+07 | 0.2 | 9.80E+07 | 97029.9 |
| 0.0336 | 0.0447 | 37.0 | 266.1964 | 0.5 | 54006.62 | 136132.8 |
| 0.0297 | 0.0439 | 80.2 | 132.6002 | 0.3 | 68255.46 | 136132.8 |
| 0.0256 | 0.0539 | 104. | 113.1406 | 0.1 | 139239.2 | 153397.8 |
| 0.0231 | 0.0614 | 116 | 94.51954 | 0.0 | 5067.04 | 153397.8 |
| 0.0229 | 0.0612 | 108 | 116.7009 | 0.1 | 82594.56 | 153397.8 |
| 0.0254 | 0.0651 | 100 | 97.92344 | 0.2 | 62352.54 | 159626.4 |
| 0.0325 | 0.0904 | 82.9 | 46.7057 | 0.2 | 62140.25 | 143076.9 |
| 0.0474 | 0.1047 | 59.0 | 29.71128 | 0.3 | 32295.59 | 9.41E+07 |
| 0.0337 | 0.0428 | 0.01 | 3.74E+07 | 4.0 | 86865.89 | 117257.9 |
| 0.0336 | 0.0463 | 0.32 | 2.26E+08 | 1.5 | 7.62E+07 | 7.62E+07 |
| 0.0317 | 0.0434 | 14.6 | 7852.2115 | 0.9 | 11969.85 | 143076.9 |
| 0.0336 | 0.0440 | 36.7 | 267.6627 | 0.5 | 9.90E+07 | 101000 |
| 0.0242 | 0.0454 | 86.9 | 150.9714 | 0.5 | 66897.18 | 148866.4 |
| 0.0215 | 0.0504 | 109 | 138.1298 | 0.3 | 138869 | 138869 |
| 0.0199 | 0.0528 | 115 | 144.5568 | 0.2 | 29720.56 | 154931.8 |
| 0.0190 | 0.0480 | 108 | 157.9708 | 0.3 | 42443.77 | 143076.9 |
| 0.0187 | 0.0507 | 109 | 155.8182 | 0.2 | 19029.68 | 125716.3 |
| 0.0180 | 0.0487 | 96.4 | 163.3582 | 0.2 | 81117.65 | 1.10E+08 |
| 0.0177 | 0.0478 | 79.1 | 171.8245 | 0.3 | 95099.01 | 1.05E+08 |
| 0.0176 | 0.0479 | 63.0 | 179.6613 | 0.4 | 47169.75 | 1.27E+08 |
| 0.0317 | 0.0498 | 0.11 | 8.95E+07 | 5.4 | 15181.61 | 9.90E+07 |
| 0.0312 | 0.0430 | 1.41 | 7171.182 | 1.5 | 8.02E+07 | 1.24E+08 |
| 0.0292 | 0.0523 | 7.58 | 1.03E+08 | 1.5 | 75390.74 | 9.51E+07 |
| 0.0267 | 0.0445 | 31.0 | 417.6118 | 1.0 | 72214.74 | 102010 |
| 0.0227 | 0.0460 | 68.7 | 204.0465 | 0.8 | 35767.7 | 147412.3 |
| 0.0204 | 0.0483 | 93.2 | 171.7183 | 0.7 | 32817.08 | 148886.4 |
| 0.0189 | 0.0519 | 109. | 167.8084 | 0.5 | 8.77E+07 | 150375.2 |
| 0.0181 | 0.0492 | 108. | 184.4907 | 0.5 | 31725.31 | 148886.4 |
| 0.0177 | 0.0468 | 95.9 | 207.0277 | 0.5 | 25879.99 | 150375.2 |
| 0.0168 | 0.0463 | 83.8 | 212.1484 | 0.5 | 8.86E+07 | 153397.8 |
| 0.0178 | 0.0656 | 83.8 | 151.6078 | 0.5 | 95099.01 | 105101 |
| 0.0161 | 0.0474 | 52.9 | 231.8809 | 0.7 | 16152.41 | 136132.8 |
| 0.0313 | 0.0386 | 0 | 4592.258 | 0 | 1.00E+09 | 106152 |
| 0.0300 | 0.0430 | 2.80 | 8.62E+07 | 1.6 | 83451.39 | 119614.8 |
| 0.0300 | 0.0431 | 0 | 386.3951 | 0 | 19446.95 | 109368.5 |
| 0.0242 | 0.0450 | 46.2 | 293.0981 | 1.0 | 7.25E+07 | 137494.1 |
| 0.0211 | 0.0473 | 77.1 | 195.8661 | 0.8 | 9.61E+07 | 89446.16 |
| 0.0194 | 0.0513 | 97.9 | 177.1967 | 0.7 | 8.69E+07 | 140364.4 |
| 0.0186 | 0.0486 | 103. | 189.0745 | 0.7 | 7.78E+07 | 120940.4 |
| 0.0177 | 0.0471 | 102. | 198.7121 | 0.7 | 9.04E+07 | 67628.66 |
| 0.0164 | 0.0456 | 101 | 102.8015 | 0.7 | 1.13E+08 | 27192.43 |
| 0.0154 | 0.0450 | 77.6 | 183.0196 | 0.7 | 1.08E+08 | 14811.42 |
| 0.0155 | 0.0573 | 65 | 133.1078 | 0.8 | 1.00E+09 | 8890.916 |
| 0.0153 | 0.0437 | 44 | 157.4825 | 1.2 | | |

The values in Table 8 represent solutions that are close to the charge control map and represent physically significant solutions of the FET's electrical structure. However, the values represented in Table 8 contain the influence of external layout parasitics which are subtracted using a model for the embedding parasitics to obtain the most accurate charge control mapping to the intrinsic device characteristic. In particular, an embedding model is applied filter the extracted equivalent circuit model values and obtain values more representative of the intrinsic device. In particular, in the exemplary embodiment, a PiFET embedding parasitic model is used to subtract capacitive contributions due to interelectrode and off-mesa layout parasitic influences. This filter essentially subtracts known quantities formed from the parameters Cgs, Cgd and Cds depending on the device layout involved. In this example, embedding of the inductive parameters is not necessary because these quantities are extrinsic and do not contribute to the charge control map of the intrinsic device.

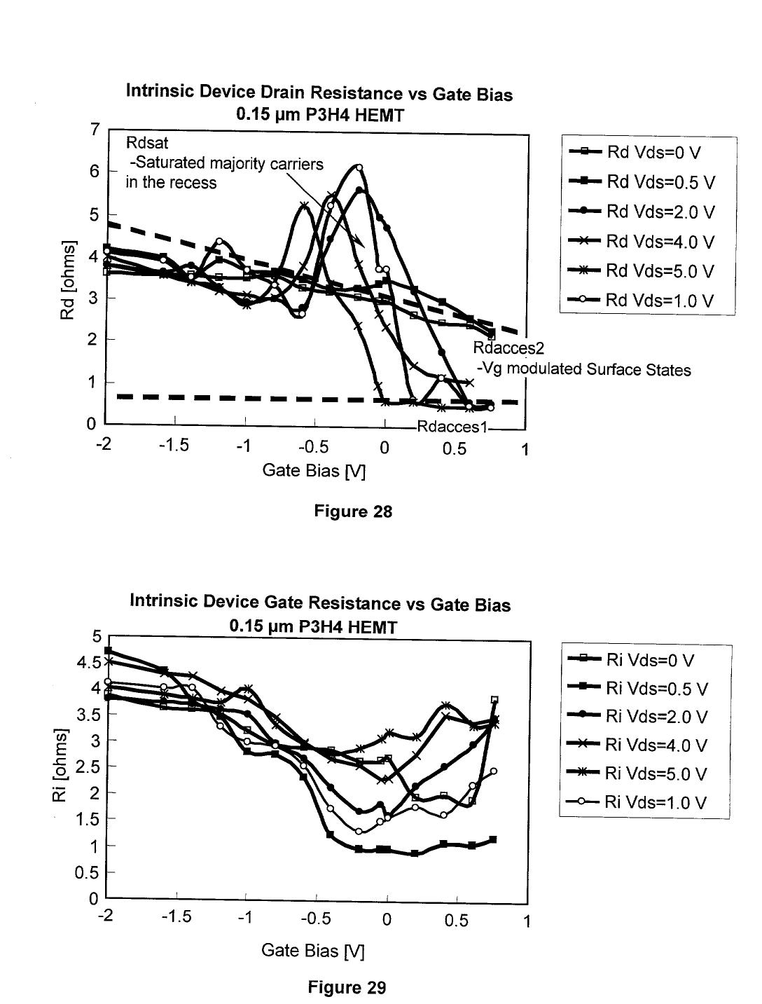

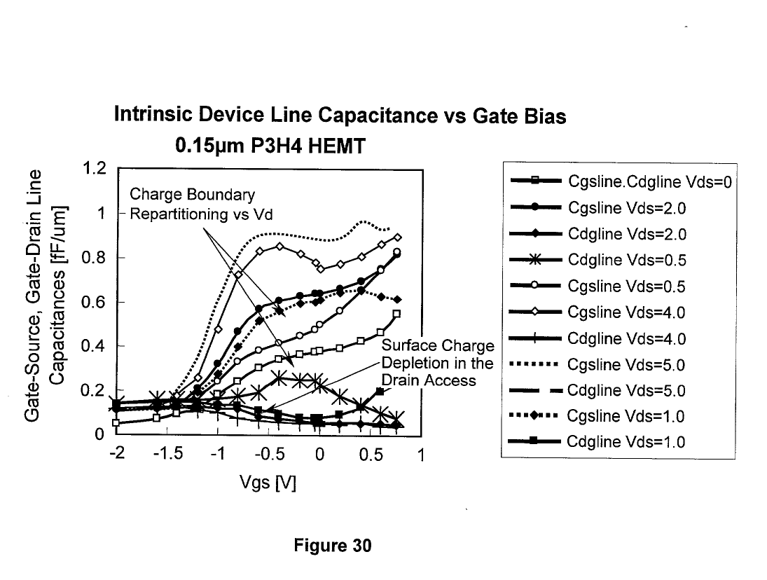

As discussed above, the lens with filter are used to generate unique charge control maps. In particular, FIGS. 27-30 illustrate the bias dependent charge control maps for the parameters RS, RD, RI, CGS and CGD as a function of bias. More particularly, FIG. 27 illustrates a charge control map of the charge and electric field distribution in the on-mesa source access region illustrated by the source resistance Rₛ as a function of bias. FIG. 28 illustrates a charge control map of the charge and electric field distribution in the on-mesa drain access region illustrated by the drain resistance R_{d} as a function of bias. FIG. 29 illustrates a charge control map for a non-quasistatic majority carrier transport illustrated by the intrinsic device charging resistance Rᵢ as a function of gate bias for different drain bias points. FIG. 30 illustrates a charge control map for gate modulated charge and distribution under the gate shown with the gate capacitance CGS and CGD as a function of bias.

### Filter

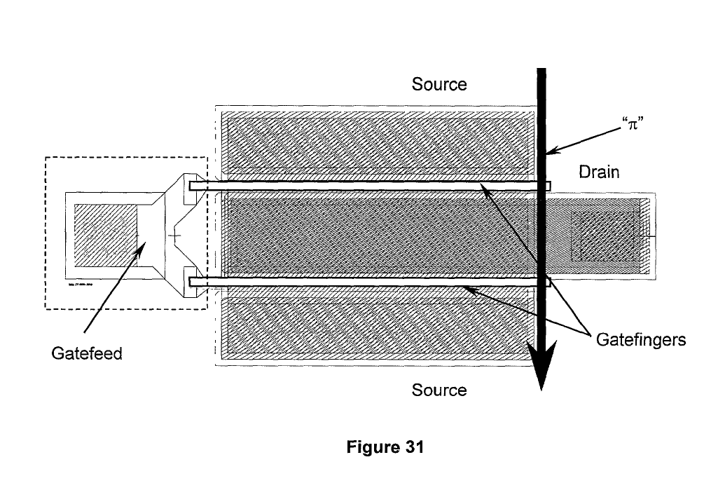

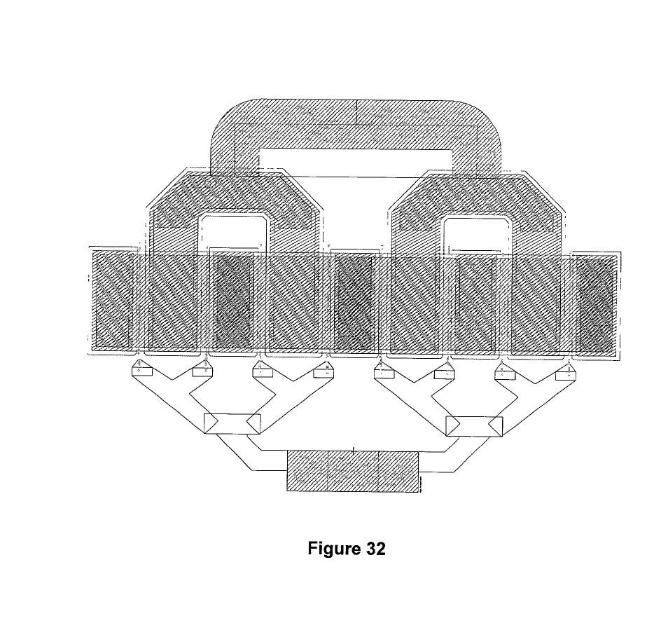

As mentioned above, the S-parameter microscope 20 may utilize a filter to provide a clearer charge control map for modeling the internal electric charge/field of a semiconductor device. Although the filter is illustrated in connection with the PiFET with multiple gate fingers, as illustrated in FIGS. 31 and 32, the principles of the invention are applicable to other semiconductor devices.

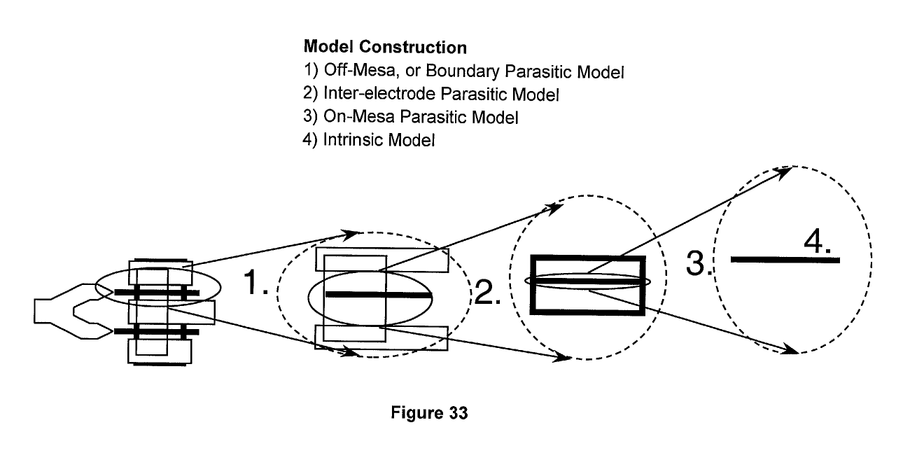

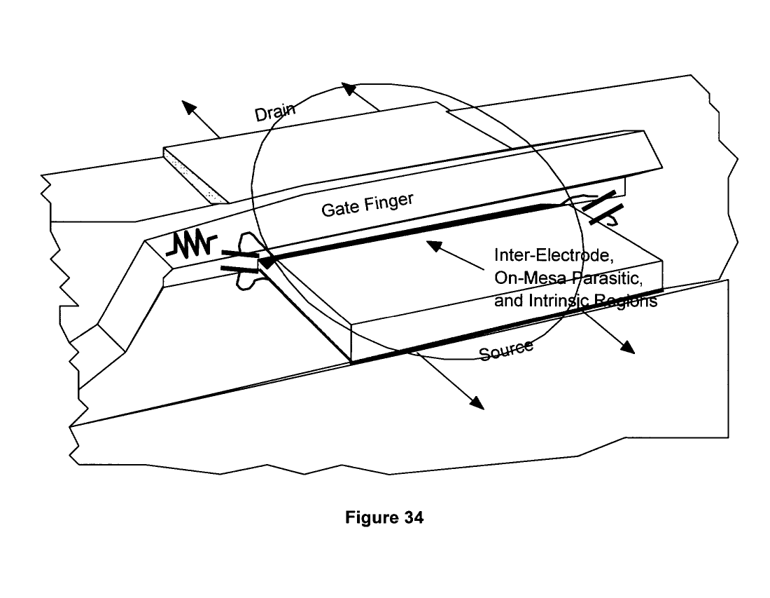

As illustrated in FIG. 31, PiFETs are devices in which the gate fingers and the edge of the active region resemble the greek letter π, as illustrated. Such PiFET layouts facilitate construction of multi fingered large periphery device cells, for example, as illustrated in FIG. 32. In accordance with an important aspect of the invention, the multi-finger semiconductor device is modeled as a combination of single finger device cells. Each single finger device cell is represented by a hierarchy of four models, which, in turn, are assembled together using models for interconnects to represent an arbitrary multifingered device cell, illustrated in FIG. 33. The four models are as follows: off mesa or boundary parasitic model; interelectrode parasitic model; on-mesa parasitic model and intrinsic model.

The off-mesa parasitic model is illustrated in FIG. 34. This model represents the parasitics that exist outside the active FET region for each gate finger. In this model, the fringing capacitance of each gate finger off the active device region as well as the off-mesa gate finger resistance is modeled.

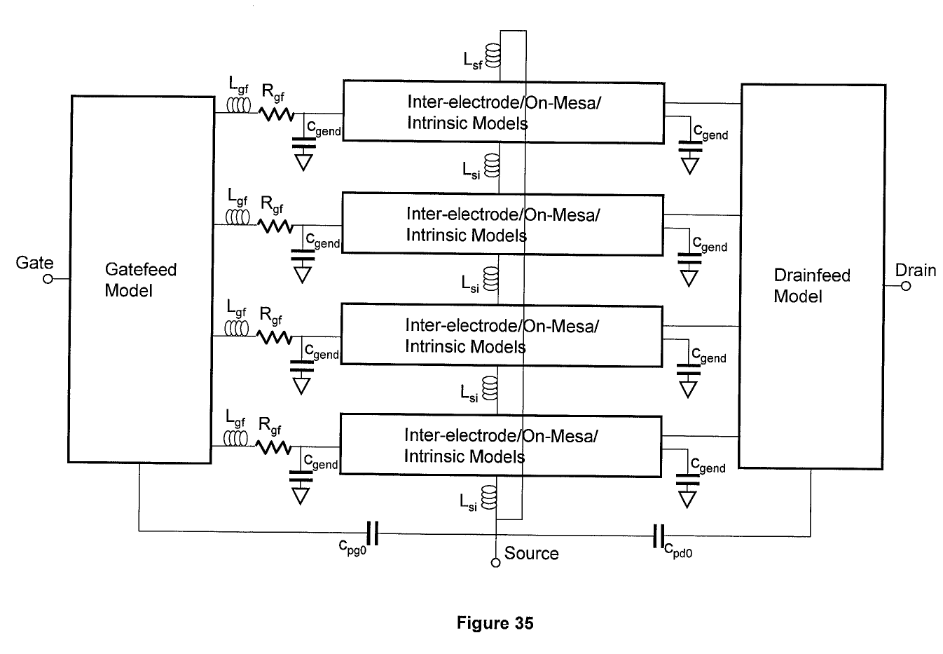

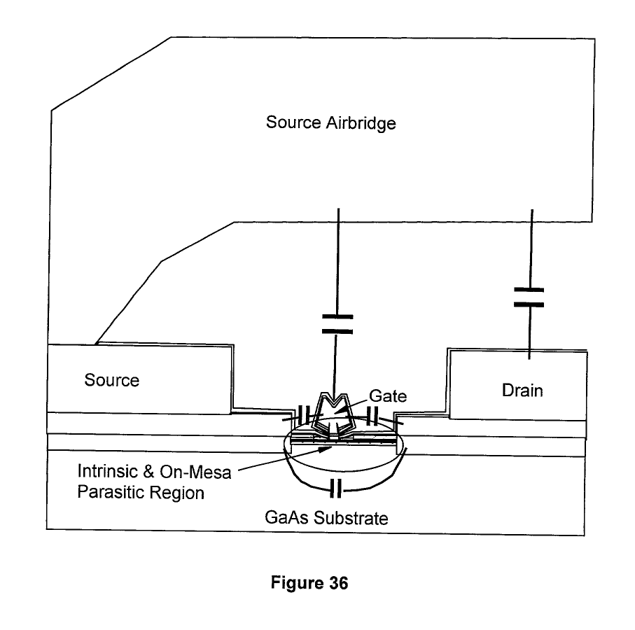

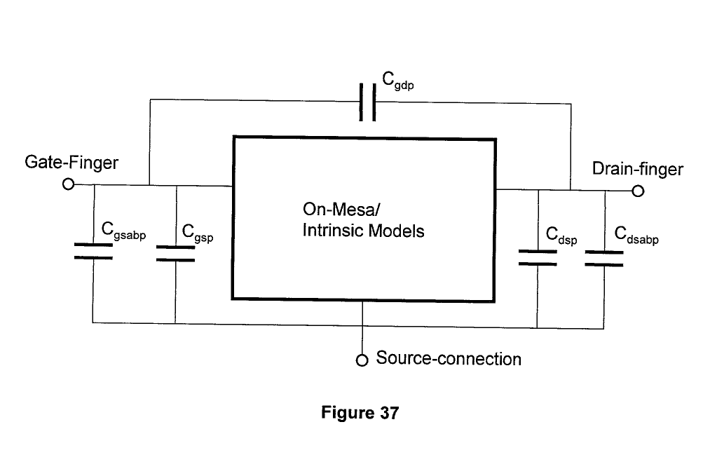

The interelectrode parasitic model and corresponding equivalent circuit are illustrated in FIGS. 35-37. This model represents parasitics between the metal electrodes along each gate finger. The following fringing capacitance parasitics are modeled for the gate-to-source air bridge; drain-to-source air bridge; gate-to-source ohmic; gate-to-drain ohmic and source-to-drain ohmic as generally illustrated in FIG. 36.

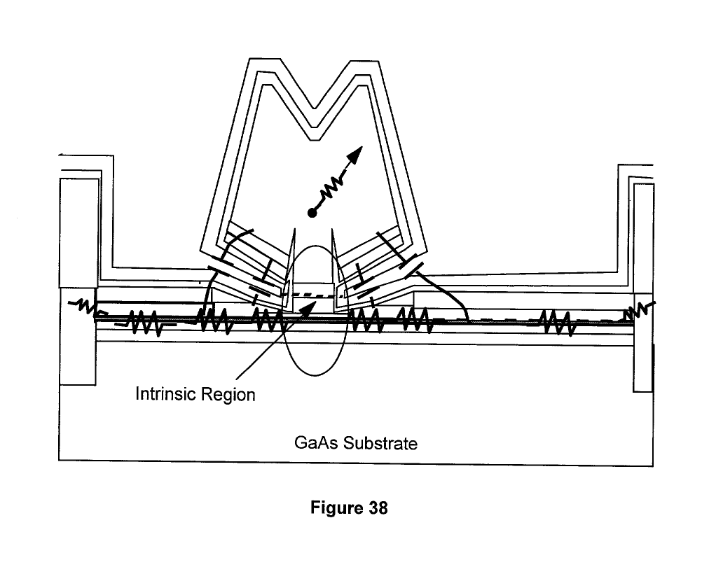

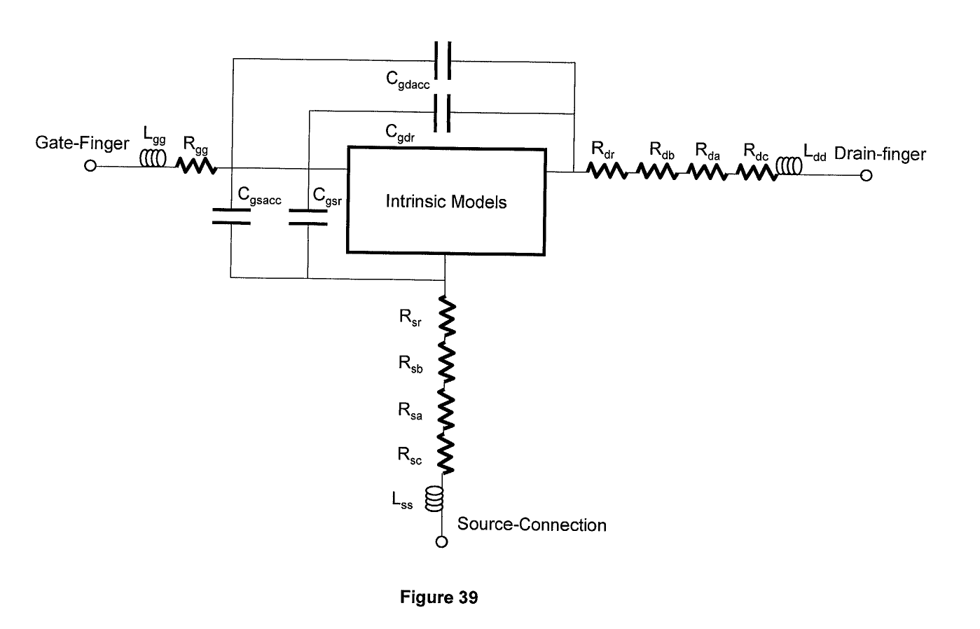

The on-mesa parasitic model and corresponding equivalent circuit are illustrated in FIGS. 38 and 39. This model represents that parasitics around the active FET region along each gate finger including various capacitance fringing parasitics and resistive parasitics. In particular, the gate-to-source side recess; gate-drain-side recess; gate-source access charge/doped cap; and gate-drain access charge/doped cap capacitance fringing parasitics are modeled. In addition, the gate metallization and ohmic contact resistive parasitics are modeled.

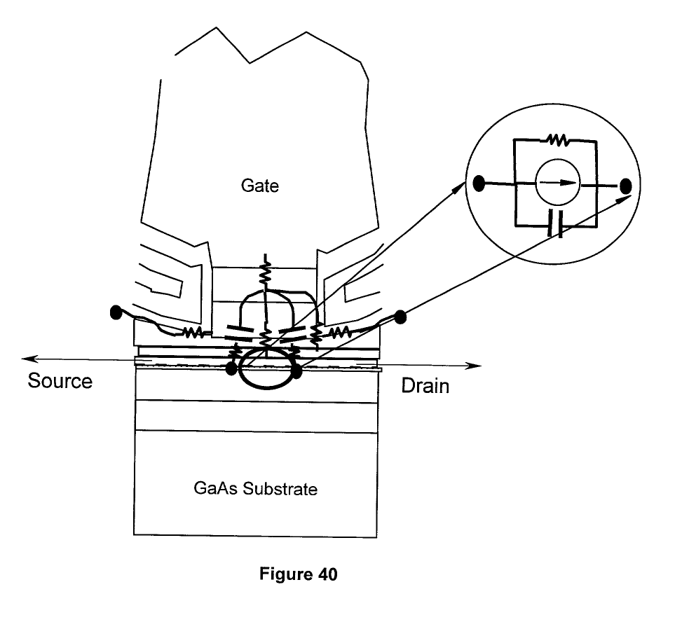

The intrinsic model and corresponding equivalent circuit are illustrated in FIGS. 40 and 41. The intrinsic model represents the physics that predominately determine the FET performance. In particular, the DC and current voltage response can be determined by physics based analytical equations for magnitude and location of intrinsic charge which are generally know in the art, for example, as disclosed in “Nonlinear Charge Control in AlGaAs/GaAs Modulation-Doped FETs”, by Hughes, et al., IEEE Trans. Electron Devices, Vol. ED-34, No. 8, August 1987. The small signal model performance is modeled by taking a derivative of the appropriate charge or current control equations to derive various terms such as RI, RJ, RDS, RGS, RGD, GM, TAU, CGS, CDS and CGD. Such control equations are generally known in the art and disclosed in detail in the Hughes, et al. reference mentioned above, hereby incorporated by reference. The noise performance may be modeled by current or voltage perturbation analysis “Noise Characteristics of Gallium Arsenide Filed-Effect Transistors” by H. Statz, et al. IEEE-Trans. Electronic Devices, vol. ED-21, No. 9, September 1974 and “Gate Noise in Field Effect Transistors at moderately High Frequencies” by A. Van Der Ziel, Pro. IEEE, vol 51, March 1963 “Gate Noise in Field Effect Transistors at Moderately High Frequencies”, by H. Statz, IEEE Trans. Electron Devices, vol. ED-21, No. 9, September 1974. “Noise Characteristics of Gallium Arsenole Field Effect Transistors”, by Statz et al, IEEE Trans. Electron Devices, vol. ED-21, No. 9, September 1974.

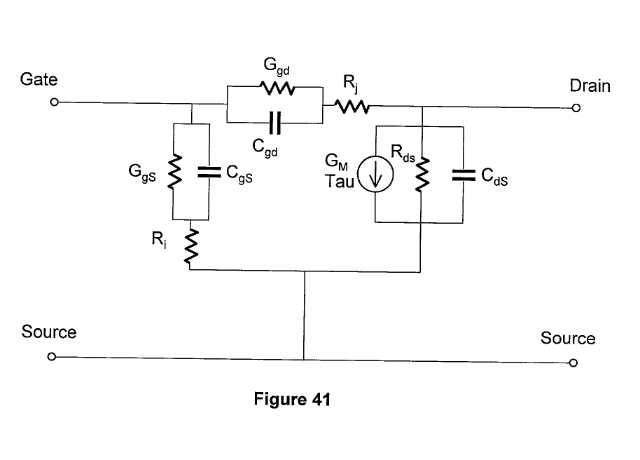

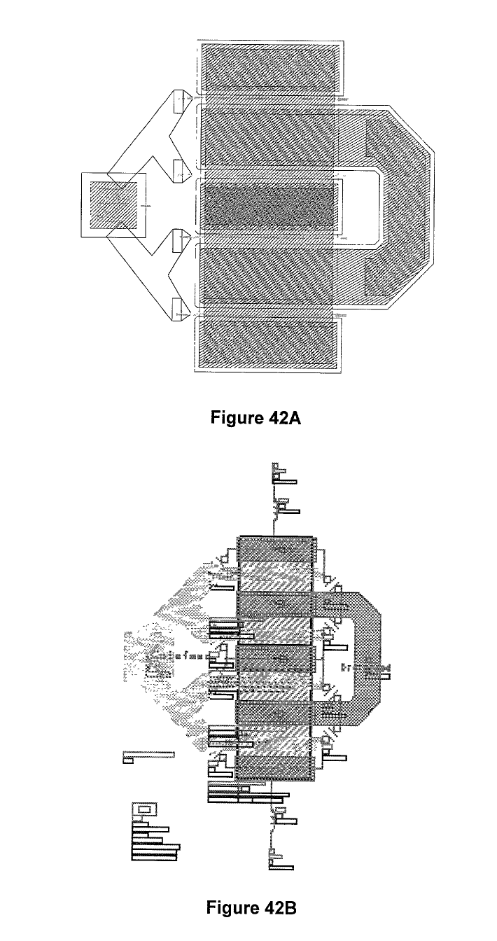

An example of a parasitic model for use with the S-parameter microscopy discussed above is illustrated in FIGS. 42-49. Although a specific embodiment of a semiconductor device is illustrated and described, the principles of the present invention are applicable to various semiconductors devices. Referring to FIG. 42A, a Pi-FET is illustrated. As shown, the PiFET has four gate fingers. The four fingered Pi-FET is modeled in FIG. 42B. In particular, FIG. 42B illustrates an equivalent circuit model for Pi-FET illustrated in FIG. 42A as implemented by a known CAD program, for example, LIBRA 6.1 as manufactured by Agilent Technologies. As shown, the equivalent circuit models does not illustrate all of the equivalent circuit elements or network connections involved with implementing the parasitic embedding models, but rather demonstrates a finished product. The actual technical information regarding the construction of the network and its equivalent circuit elements are normally provided in schematic view. An important aspect of parasitic modeling relates to modeling of multi-gate fingered devices as single gate finger devices. As used herein, a single unit device cell refers to a device associated with a single gate finger. For example, a four fingered Pi-FET as illustrated in FIG. 42A is modeled as four unit device cells.

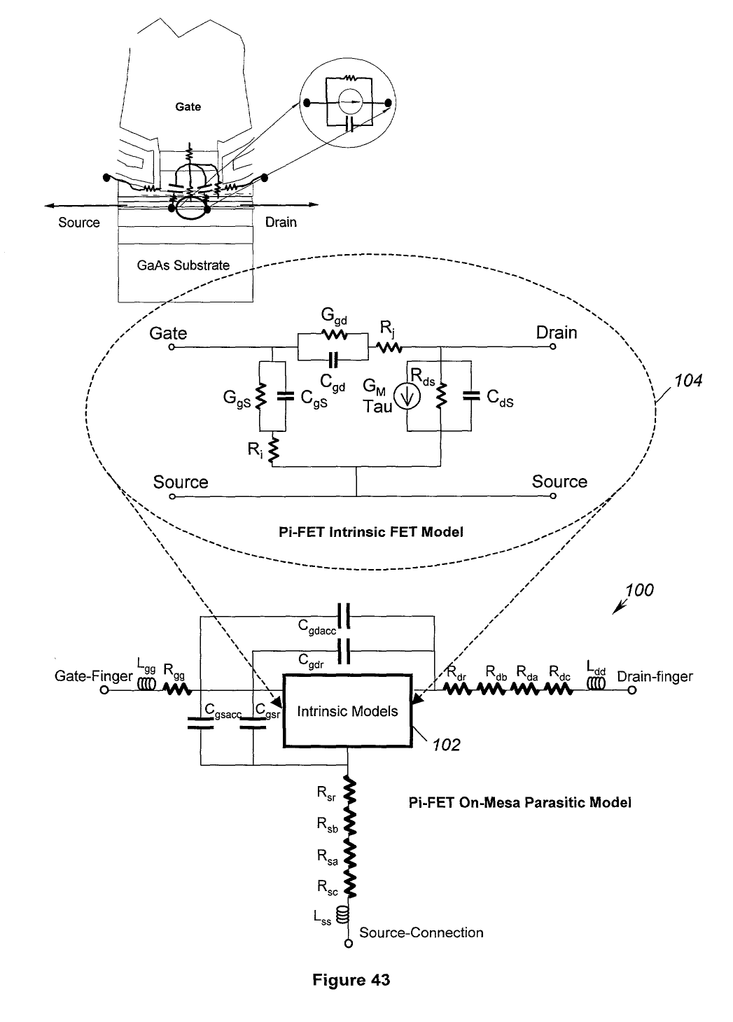

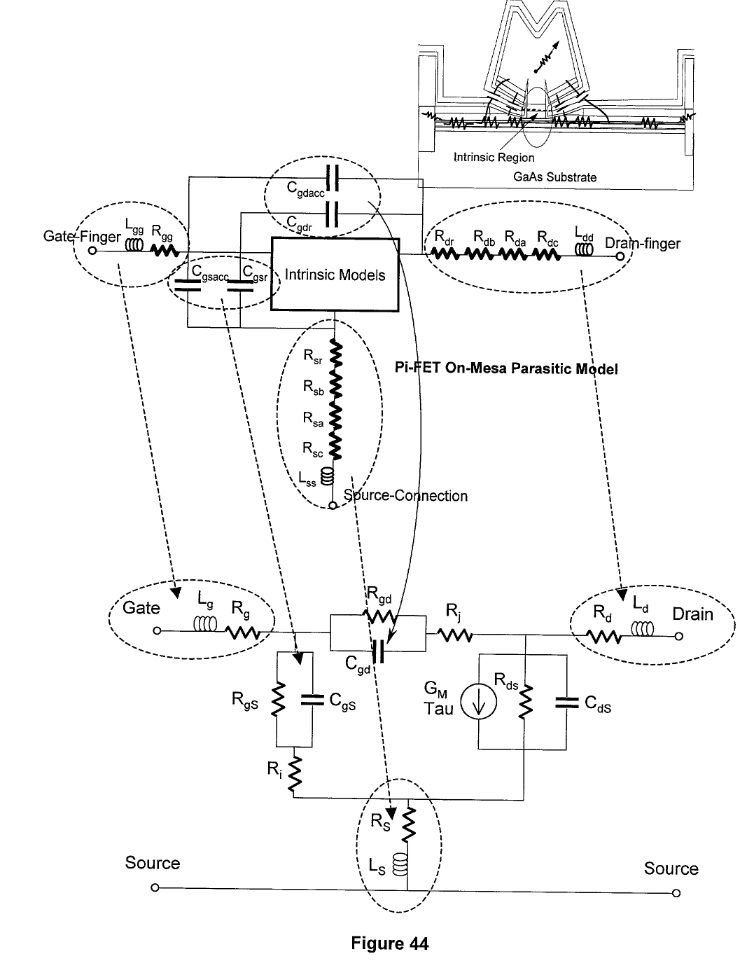

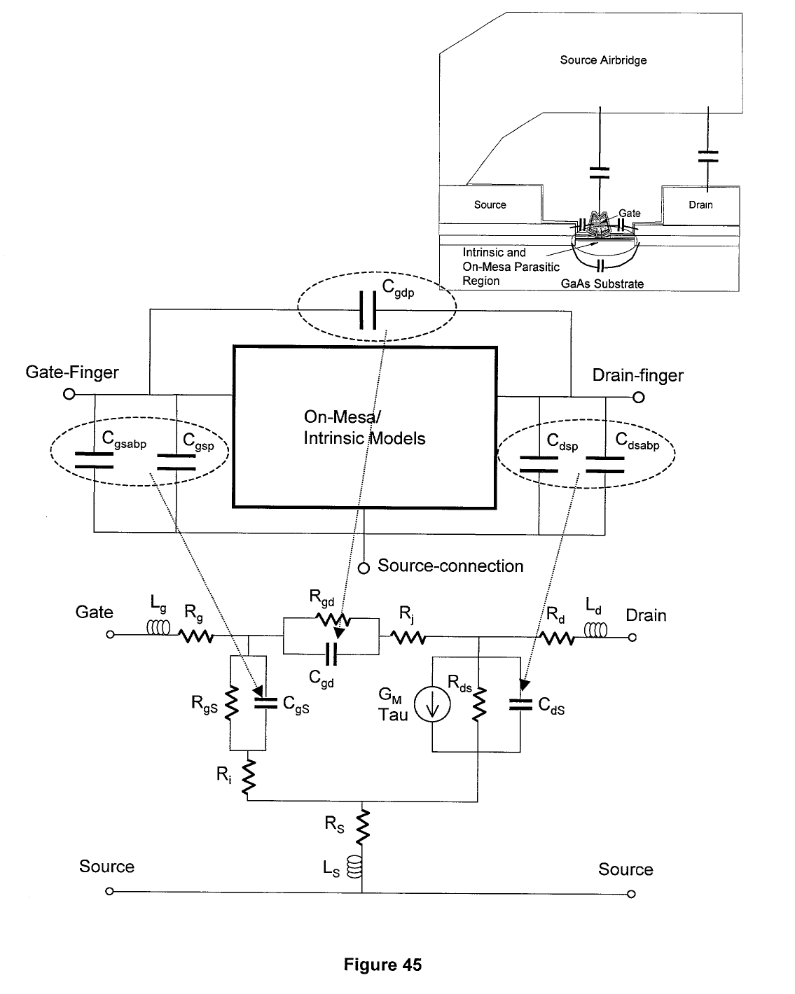

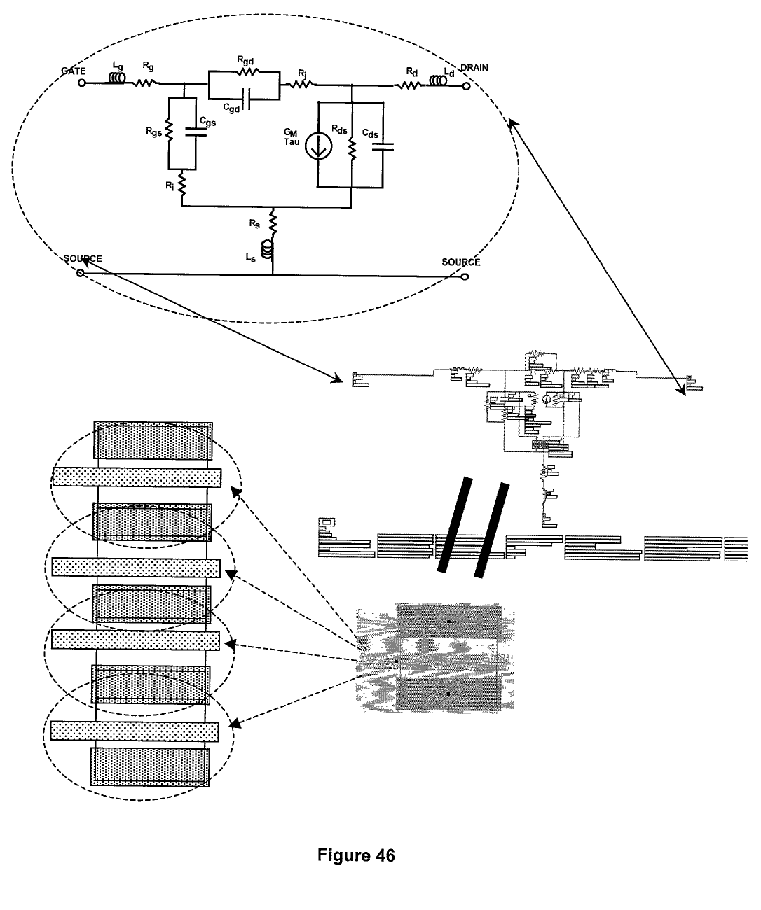

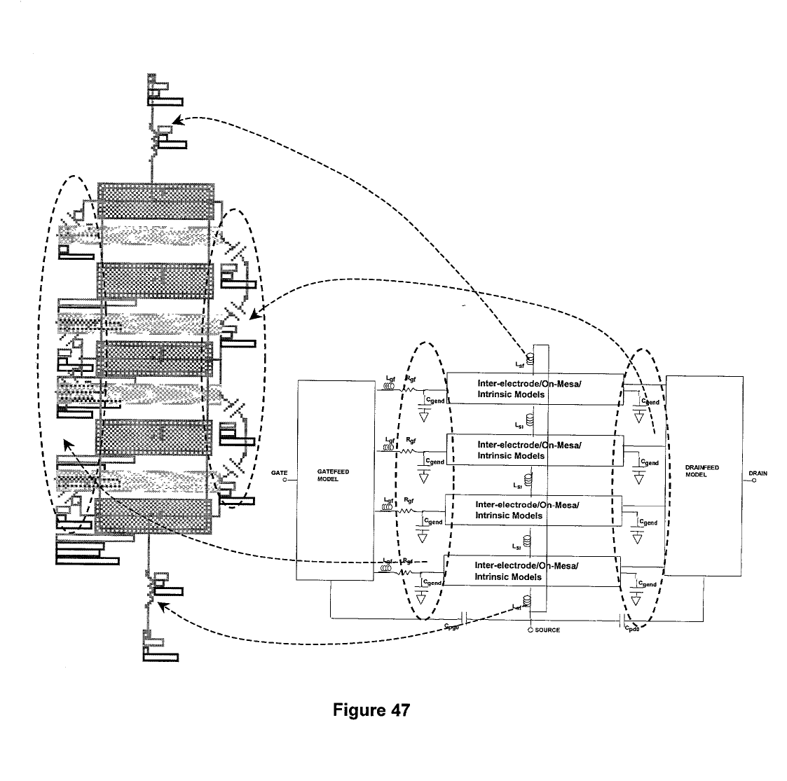

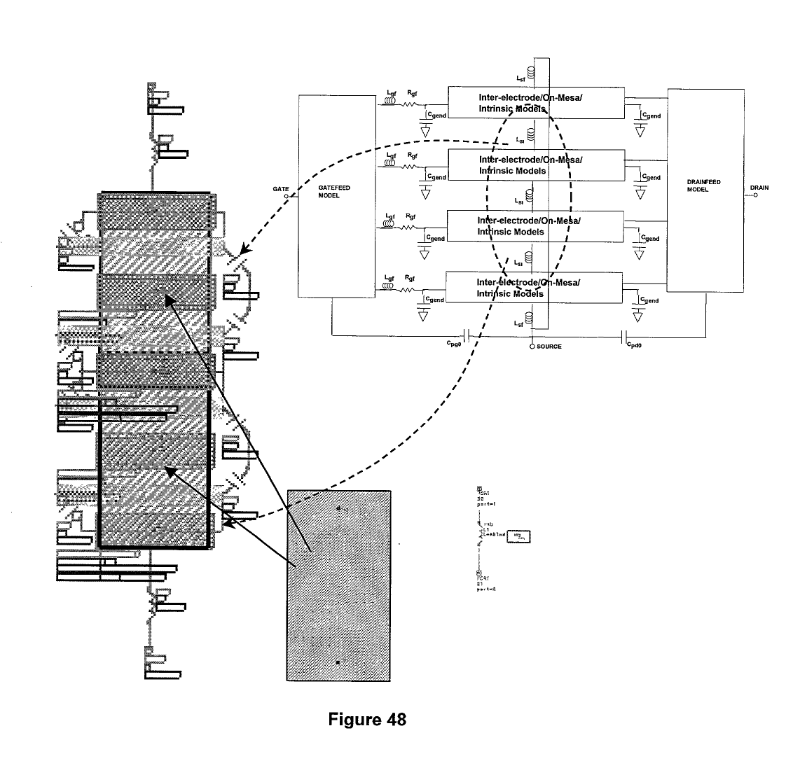

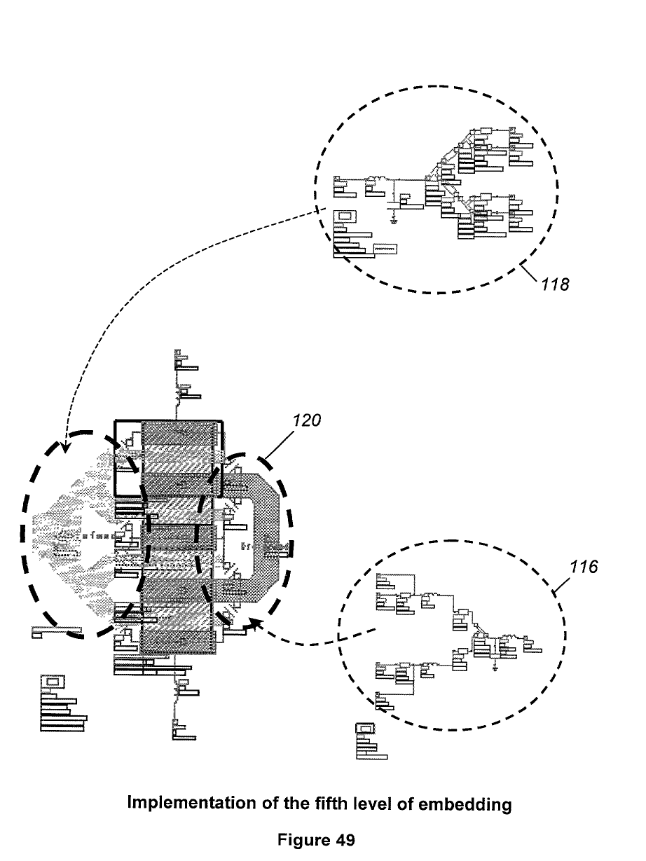

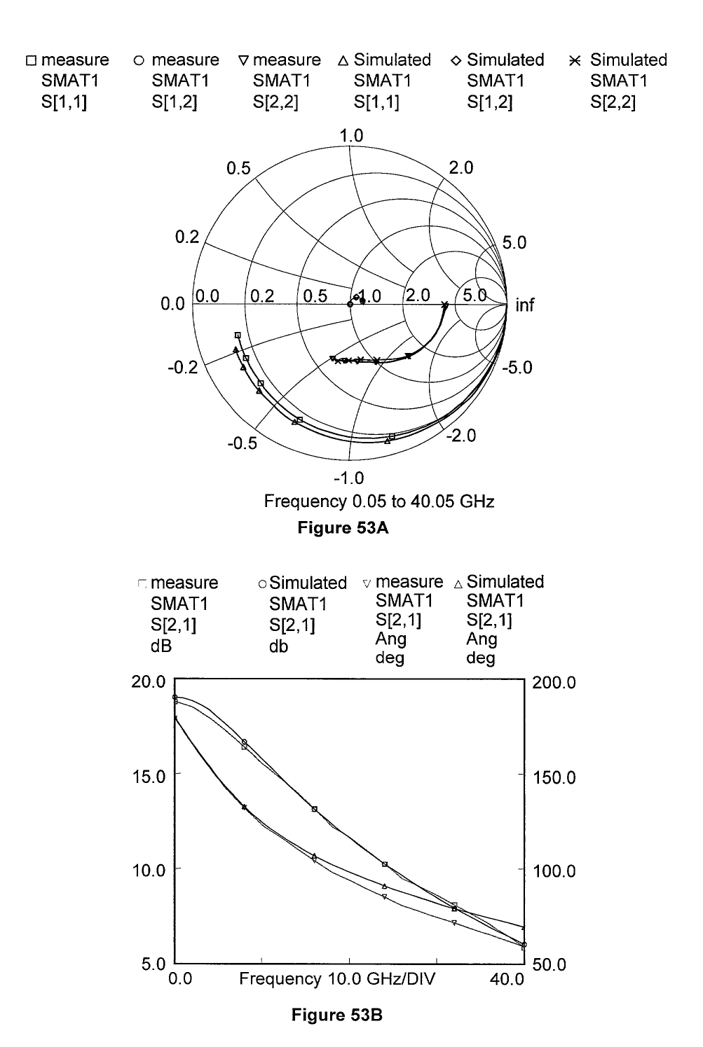

Initially, the four finger Pi-FET illustrated in FIG. 42A, is modeled as a single finger unit device cell 100 with an intrinsic model 102, as shown in FIGS. 43 and 44. In particular, the Pi-FET intrinsic FET model 104 is substituted for the block 102 defining a first level of embedding. As shown in FIG. 44, the parameter values for the Pi-FET intrinsic model are added together with the parameter values for the single fingered unit device cell intrinsic model. The intrinsic device model 104 may be developed by S-parameter microscopy as discussed above. Next, as illustrated in FIG. 45, the interconnect layout parasitic elements are added to the equivalent model by simply adding the model terms to the value of the appropriate circuit element to form a single unit device cell defining a second level of embedding. Once the single unit device cell is formulated, this device is used to construct models for multi-fingered devices. In this case, a Pi-FET with four gate fingers is modeled as four single finger device unit cells as shown in FIG. 46. Subsequently, the off-mesa layout parasitic elements are connected to the multi-fingered layout, defining a third level of embedding as illustrated in FIG. 47. These off-mesa layout parasitic elements, generally identified with the reference numerals 108 and 110, are implemented as new circuit elements connected at key outer nodes of the equivalent circuit structure. Subsequently, a fourth level of embedding is implemented as generally illustrated in FIG. 48. In particular, an inductor model is connected to the sources of each of the various unit device cells to represent the metallic bridge interconnection, as generally shown in FIG. 48. Lastly, as illustrated in FIG. 49, a fifth level of embedding is implemented in which the feed electrodes model 114 and 116 are modeled as lumped linear elements (i.e. capacitors inductors) as well as the distributive elements (i.e. microstrip lines and junctions) to form the gate feed and drain connections illustrated in FIG. 53. As shown, the distributive elements are distributed models for microstrip elements as implemented in LIBRA 6.1.

### Extraction Method for Unique Determination of FET Equivalent Circuit Models

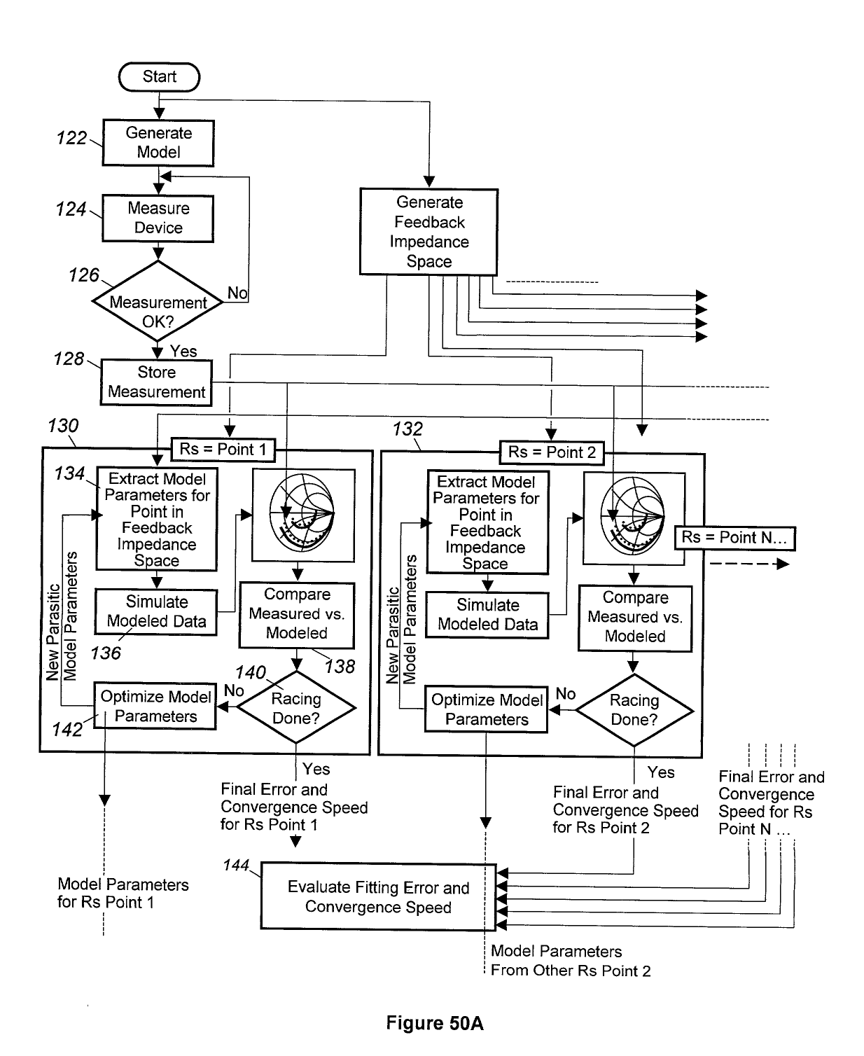

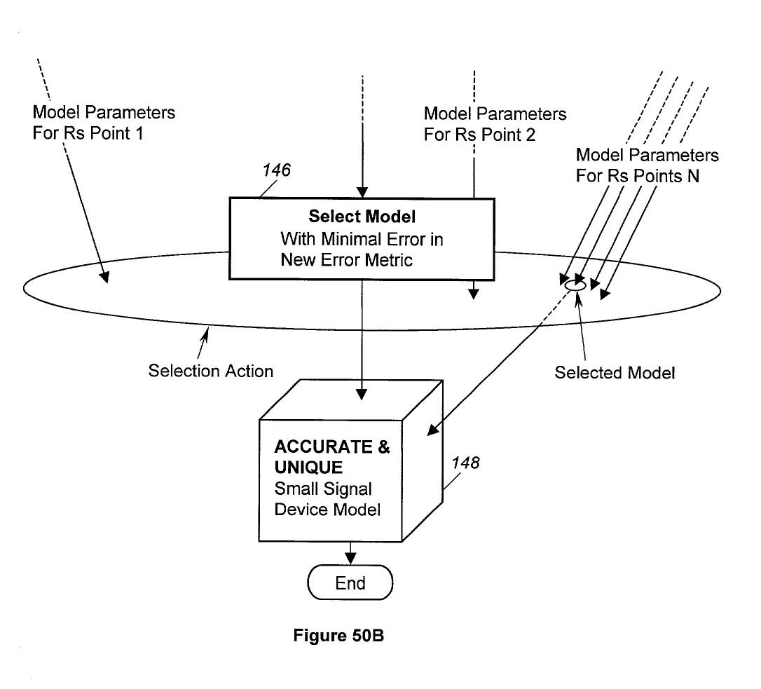

The method for determining FET equivalent circuit parameters as discussed above is illustrated in FIGS. 50-55. This method is based on an equivalent circuit model, such as the common source FET equivalent circuit model illustrated in FIG. 5. Referring to FIG. 50A, a model is initially generated in step 122. In accordance with an important aspect of the algorithm, the equivalent circuit parameters are based upon measured FET S-parameters. Measurement of S-parameters of semiconductor devices is well known in the art. FIG. 53A is a Smith chart illustrating exemplary measured S-parameters S11, S12 and S22 for frequencies between 0.05 to 40 GHz. FIG. 53B represents a magnitude angle chart for the measured S-parameter S21 from frequencies from 0.05 to 40 GHz. After the S-parameters are measured, as set forth in step 124 (FIG. 50A), it is ascertained whether the measurements are suitable in step 126. This is either done by manually inspecting the test result for anomalies, or by algorithms to validate the test set. If the measurements are suitable, the S-parameter measurements are stored in step 128.

A space of trial starting feedback impedance point values, for example, as illustrated in Table 9 is chosen. Then, a direct model extraction algorithm, known as the Minasian algorithm, is used to generate preliminary values for the equivalent circuit model parameters, for each value of starting feedback impedance. Such extraction algorithms are well known in the art, for example, as disclosed “Broadband Determination of the FET Small Equivalent Small Signal Circuit” by M. Berroth, et al., IEEE—MTT, Vol. 38, No. 7, July 1990. Model parameter values are determined for each of the starting impedance point values illustrated in Table 3. In particular, referring to FIG. 50A, each impedance point in Table 9 is processed by the blocks 130, 132, etc. to develop model parameter values for each of the impedance point in order to develop an error metric, which, in turn, is used to develop a unique small signal device model, as will be discussed below. The processing in each of the blocks 130, 132 is similar. Thus, only a single block 130 will be discussed for an exemplary impedance point illustrated in Table 9. In this example, the feedback impedance point 17 which correlates to a source resistance Rₛ ohm of 1.70 and a source inductance Lₛ of 0.0045 pH is used.

TABLE 9
Trial Starting Feedback, Impedance Space Point Values

| Impedance | Resistance | Inductance |
|---|---|---|
| Point | (Rs) | (Ls) |
| 1 | 0.1 Ω | 0.0045 pH |
| 2 | 0.2 Ω | 0.0045 pH |
| 3 | 0.3 Ω | 0.0045 pH |
| 4 | 0.4 Ω | 0.0045 pH |
| 5 | 0.5 Ω | 0.0045 pH |
| 6 | 0.6 Ω | 0.0045 pH |
| 7 | 0.7 Ω | 0.0045 pH |
| 8 | 0.8 Ω | 0.0045 pH |
| 9 | 0.9 Ω | 0.0045 pH |
| 10 | 1.0 Ω | 0.0045 pH |
| 11 | 1.1 Ω | 0.0045 pH |
| 12 | 1.2 Ω | 0.0045 pH |
| 13 | 1.3 Ω | 0.0045 pH |
| 14 | 1.4 Ω | 0.0045 pH |
| 15 | 1.5 Ω | 0.0045 pH |
| 16 | 1.6 Ω | 0.0045 pH |
| 17 | 1.7 Ω | 0.0045 pH |
| 18 | 1.8 Ω | 0.0045 pH |
| 19 | 1.9 Ω | 0.0045 pH |
| 20 | 2.0 Ω | 0.0045 pH |
| 21 | 2.1 Ω | 0.0045 pH |
| 22 | 2.2 Ω | 0.0045 pH |
| 23 | 2.3 Ω | 0.0045 pH |
| 24 | 2.4 Ω | 0.0045 pH |
| 25 | 2.5 Ω | 0.0045 pH |
| 26 | 2.6 Ω | 0.0045 pH |
| 27 | 2.7 Ω | 0.0045 pH |
| 28 | 2.8 Ω | 0.0045 pH |
| 29 | 2.9 Ω | 0.0045 pH |
| 30 | 3.0 Ω | 0.0045 pH |

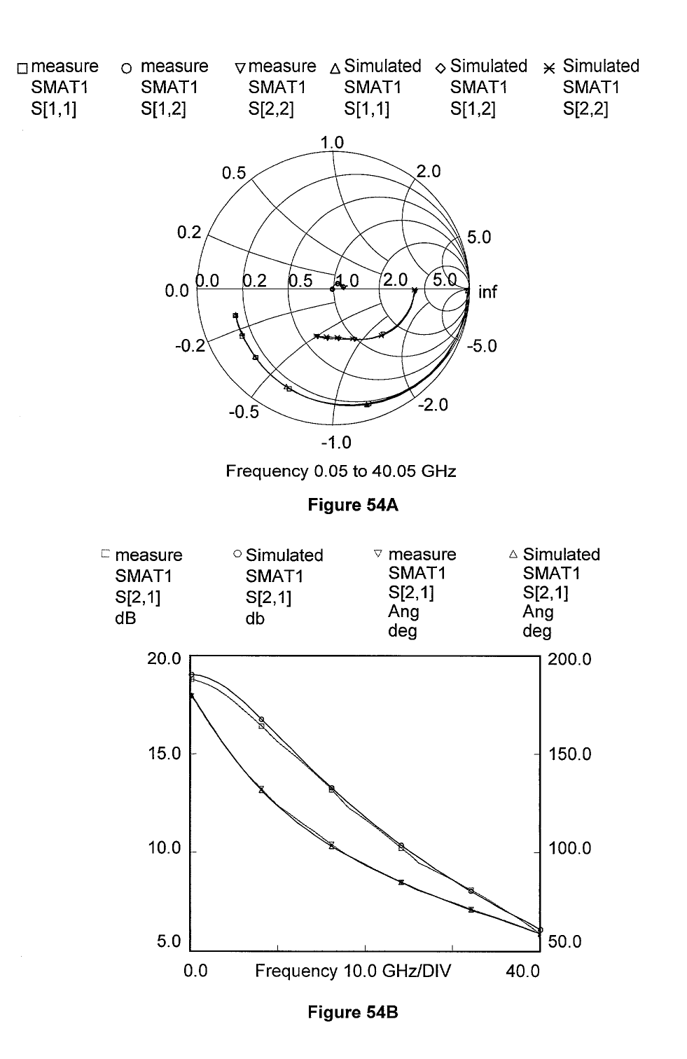

For the selected value, Rₛ=1.7 ohms, initial intrinsic equivalent circuit parameters and initial parasitic equivalent circuit parameter are determined, for example, by the Minasian algorithm discussed above and illustrated in Tables 10 and 11 as set forth in steps 134 and 136. In step 138, the simulated circuit parameters are compared with the measured S-parameters, for example, as illustrated in FIGS. 54A and 54B. Each of the processing blocks 130 and 132 etc. goes through a fixed number of complete cycles, in this example, six complete cycles. As such, the system determines in step 140 whether the six cycles are complete.

TABLE 10
Initial “Intrinsic” Equivalent Circuit Parameters

| Intrinsic Equivalent | | |
|---|---|---|
| Circuit Parameter | Initial Solution | |
| Cgs | 0.23595 | pF |
| Rgs | 91826 | Ω |
| Cgd | 0.0177 | pF |
| Rgd | 100000 | Ω |
| Cds | 0.04045 | pF |
| Rds | 142.66 | Ω |
| Gm | 142.1025 | mS |
| Tau | 0.1 | pS |

TABLE 11
Initial “Parasitic” Equivalent Circuit Parameters

| Intrinsic Equivalent | | |
|---|---|---|
| Circuit Parameter | Initial Solution | |
| Rg | 3.0 | Ω |
| Lg | 0.014 | nH |
| Rs | 1.7 | Ω |
| Ls | 0.0045 | nH |
| Rd | 2.5 | Ω |
| Ld | 0.024 | nH |

Each cycle of the processing block 130 consists of a direct extraction followed by an optimization with a fixed number of optimization iterations, for example 60. By fixing the number of extraction-optimization cycles along with the number of optimization iterations, a fixed “distance” or calculation time which the model solution must be derived is defined. As such, the algorithm implements a convergence speed requirement of the global error metric by setting up an environment where each trial model solution competes against each other by achieving the lowest fitting error over a fixed calculation time thus causing “race” criteria to be implemented where “convergence speed” is implicitly calculated for each processing block 130, 132 etc.

After the system determines whether the racing is done in step 140, the system proceeds to block 142 and optimizes model parameters. Various commercial software programs are available, for example, the commercially available, LIBRA 3.5 software as manufactured by HP-eesof may be used both for circuit simulation as well as optimizing functions. The optimization is performed in accordance with the restrictions set forth in Table 12 with the addition of fixing the feedback resistance Rₛ to a fixed value.

TABLE 12
Environment Used for Competitive Solution Strategy, as
Implemented in this Example

| Implementation Parameter | |
|---|---|
| Circuit Simulator and Optimizer | Libra 3.5 |
| Optimization Algorithm | Gradient |
| Optimization Error Metric | Mag and angle of |
| | S11, S21, S12, and S22 |
| | from 4 to 40 GHz |
| Number of Iterations | 60 |
| Number of Extraction/Optimization | 6 |
| Cycles | |

By fixing the value for Rₛ this segment of the algorithm confined to creating a trial model solution for only the trial feedback impendence point with which it started. Table 13 illustrates the optimized intrinsic equivalent parameter values using commercially available software, such as LIBRA 3.5. These values along with the optimized parasitic values, illustrated in Table 14, form the first optimized model solution for the first extraction-optimization cycle (i.e. one of six). The optimized model parameters are then fed back to the function block 134 and 136 (FIG. 50A) and used for a new initial model solution. These values are compared with the measured S-parameter value as illustrated in FIGS. 54A and 54B. The system repeats this cycle for six cycles in a similar fashion as discussed above. After the six extraction-optimization cycle, the final trial model solution for the trial impendence point 17 is complete along with its final fitting error to the measured data to form the new error metric 144. In accordance with an important aspect, the extraction-optimization algorithm makes the final optimization fitting error for each point implicitly carry information about both the measured to model fitting error and the speed of convergence. It does so by the fixed optimization time constraint which sets up a competitive race between the various trial model solutions.

TABLE 13
Optimized “Intrinsic” Equivalent Circuit Parameters

| Intrinsic Equivalent | | |
|---|---|---|
| Circuit Parameter | Initial Solution | |
| Cgs | 0.227785 | pF |
| Rgs | 65247 | Ω |
| Cgd | 0.017016 | pF |
| Rgd | 130820 | Ω |
| Cds | 0.047521 | pF |
| Rds | 160.18 | Ω |
| Gm | 135.74 | mS |
| Tau | 0.446 | pS |

TABLE 14
Optimized “Parasitic” Equivalent Circuit Parameters

| Intrinsic Equivalent | | |
|---|---|---|
| Circuit Parameter | Initial Solution | |
| Rg | 4.715 | Ω |
| Lg | 0.02903 | nH |
| Rs* | 1.7 | Ω |
| Ls | 0.002102 | nH |
| Rd | 3.2893 | Ω |
| Ld | 0.0317 | nH |

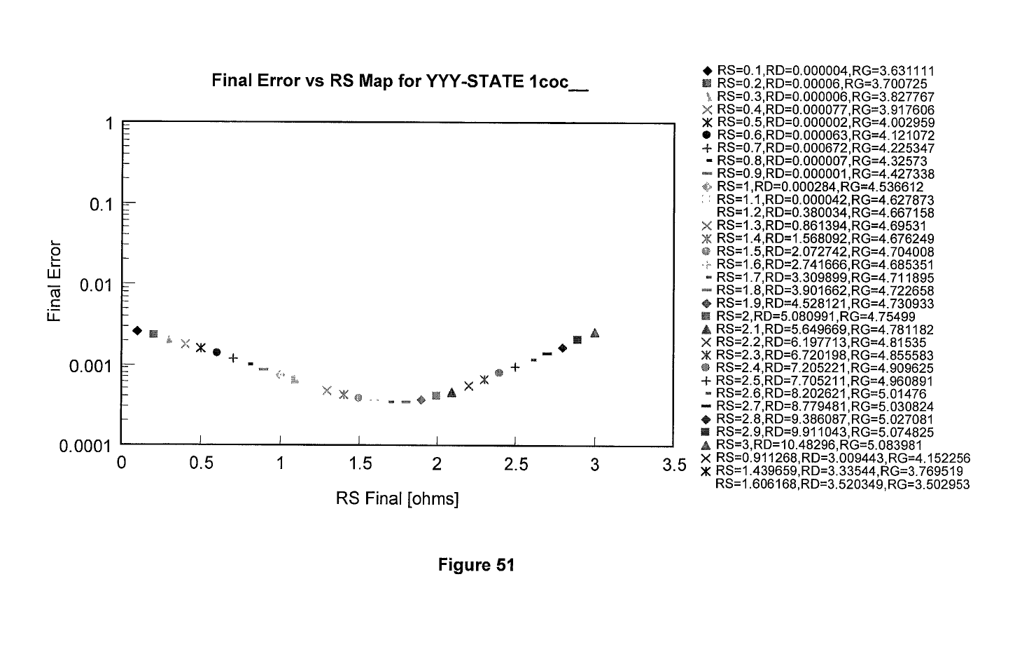

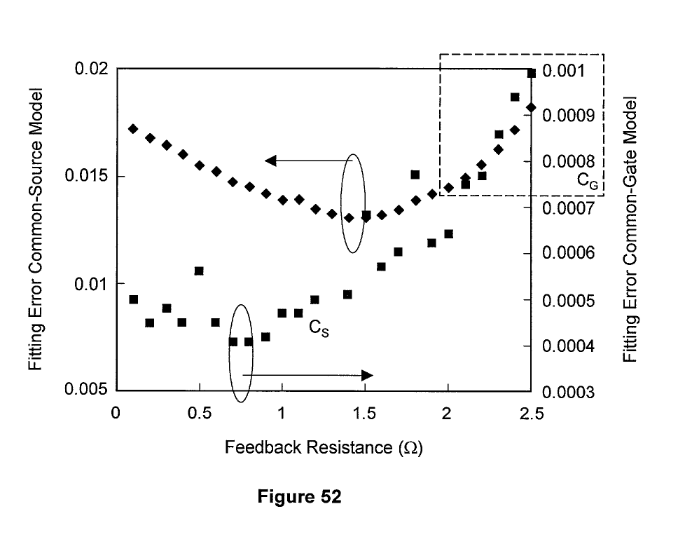

The implementation of the extraction optimization cycles makes the best and fastest solving solution appear as a global minima for the final fitting error in step 146 of all of the trial impedance points as generally shown in FIGS. 51 and 52. More specifically, referring to FIG. 51 the global minima solution using the new error metric is found around Rₛ=1.7 ohms. Tables 15 and 16 list the final model equivalent circuit parameters for this global solution, including the intrinsic and parasitic parameter as set forth in step 148 (FIG. 50B).

TABLE 15
Global Solution for “Intrinsic” Equivalent Circuit Parameters

| Intrinsic Equivalent | | |
|---|---|---|
| Circuit Parameter | Initial Solution | |
| Cgs | 0.227745 | pF |
| Rgs | 64242 | Ω |
| Cgd | 0.017019 | pF |
| Rgd | 133450 | Ω |
| Cds | 0.047544 | pF |
| Rds | 160.1791 | Ω |
| Gm | 135.7568 | mS |
| Tau | 0.443867 | pS |

TABLE 16
Global Solution “Parasitic” Equivalent Circuit Parameters

| Extrinsic Equivalent | | |
|---|---|---|
| Circuit Parameter | Initial Solution | |
| Rg | 4.711895 | Ω |
| Lg | 0.029314 | nH |
| Rs | 1.7 | Ω |
| Ls | 0.002104 | nH |
| Rd | 3.309899 | Ω |
| Ld | 0.031671 | nH |

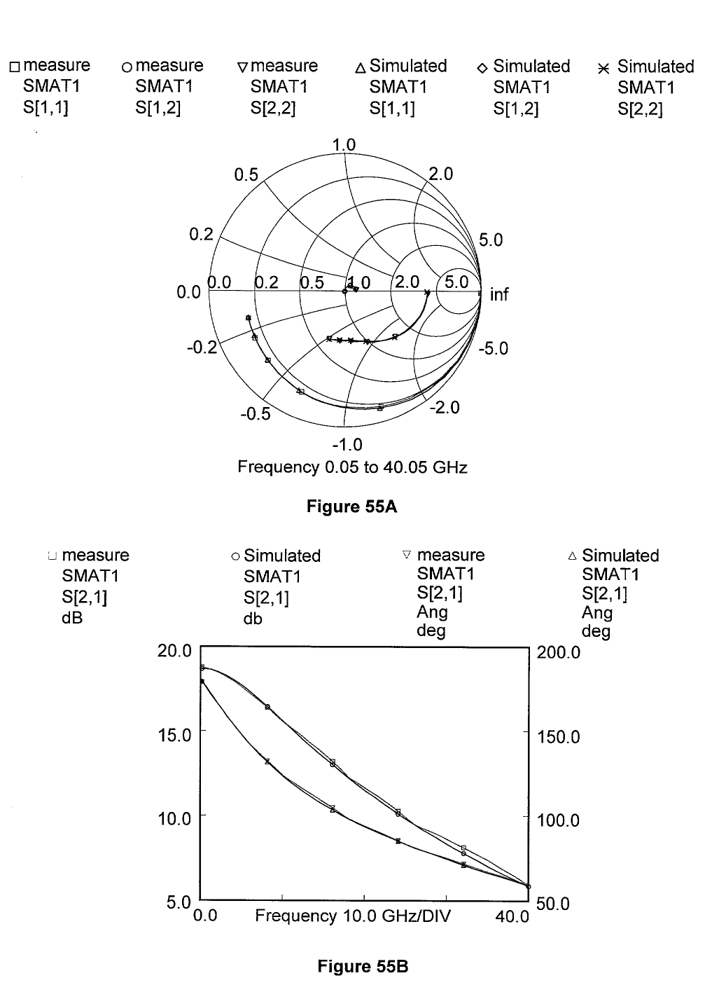

In order to test the accuracy of the solution, the final model for solutions are compared with the measured S-parameter values as shown in FIGS. 55A and 55B. As shown, there is good correlation between the simulated model values and the measured S-parameters values thus verifying that the simulated model values represent a relatively accurate and unique small signal device model.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

I claim:

1. A method for modeling a semiconductor device comprising the steps of:
(a) modeling the semiconductor device with a semiphysical model;
(b) modeling the semiconductor device with an analytical thermal model; and
(c) coupling the semi-physical model and said analytical conduction model.

2. The method as recited in claim 1, further including step (d) determining the internal charge/electric field structure of the semiconductor device.

3. The method as recited in claim 1, wherein said semi-physical model is configured to replicate measured direct current (DC) current-voltage (I-V) characteristics.

4. The method as recited in claim 3, wherein said semi-physical model is also configured to replicate bias dependent small signal characteristics.

5. the method as recited in claim 4, wherein said semi-physical model is configured to replicate said DC I-V and bias dependent.

6. The method as recited in claim 1, wherein step (b) includes the step (e): measuring the DC-IV characteristics and the S-parameter small signal parameters across a predetermined range of temperatures.

7. The method as recited in claim 6, further including the step (f): extracting small signal equivalent circuit models for each S-parameter measurement as a function of temperature.

8. The method as recited in claim 7, further including step (g): developing temperature co-efficient which adjust the semi-physical device model to match the measured DC and S-parameter measurements at each temperature.

9. The method as recited in claim 1, wherein step (c) includes the step (h): substituting the environment temperature that operates in any temperature dependent terms and temperature co-efficient with the channel temperature of the device.

10. The method as recited in claim (a), wherein step (c) further includes step (i): using of the saturated region as the length of the heat generating region.
